(19) United States
(12) Patent Application Publication
(10) Pub. No.: US 2026/0268611 A1
(43) Pub. Date: Sep. 10, 2026

(54) GENERATING EXTENDED-REALITY (XR) CONTENT

(71) Applicant: QUALCOMM Incorporated, San Diego, CA (US)

(72) Inventor: Varun Amar REDDY, San Diego, CA (US)

(21) Appl. No.: 19/071,531

(22) Filed: Mar. 5, 2025

(51) Int. Cl. G06T 19/00; G06V 10/764; G06V 10/774; G06V 20/20

(52) U.S. Cl. CPC G06T 19/006; G06V 10/764; G06V 10/774; G06V 20/20; G06T 2219/024

(57) ABSTRACT

Systems and techniques are described herein for extended reality (XR). For instance, a method for XR is provided. The method may include obtaining, from a plurality of XR devices, a plurality of sets of image data and virtual-content data; training a machine-learning model to generate virtual content based on the plurality of sets of image data and virtual-content data; and providing the machine-learning model to an XR device, wherein the XR device is configured to use the machine-learning model to generate new virtual content. Another method may include obtaining position information from an XR device; selecting a machine-learning model from among a plurality of machine-learning models based on the position information; and providing the machine-learning model to the XR device, wherein the XR device is configured to use the machine-learning model to generate virtual content related to the position information.

### TECHNICAL FIELD

The present disclosure generally relates to extended reality (XR). For example, aspects of the present disclosure include systems and techniques for generating XR content for display.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment.

For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for extended reality (XR). According to at least one example, a method is provided for XR. The method includes: obtaining, from a plurality of XR devices, a plurality of sets of image data and virtual-content data; training a machine-learning model to generate virtual content based on the plurality of sets of image data and virtual-content data; and providing the machine-learning model to an XR device, wherein the XR device is configured to use the machine-learning model to generate new virtual content.

In another example, an apparatus for XR is provided that includes at least one memory and at least one processor (e.g., configured in circuitry) coupled to the at least one memory. The at least one processor configured to: obtain, from a plurality of XR devices, a plurality of sets of image data and virtual-content data; train a machine-learning model to generate virtual content based on the plurality of sets of image data and virtual-content data; and provide the machine-learning model to an XR device, wherein the XR device is configured to use the machine-learning model to generate new virtual content.

In another example, a non-transitory computer-readable medium is provided that has stored thereon instructions that, when executed by one or more processors, cause the one or more processors to: obtain, from a plurality of XR devices, a plurality of sets of image data and virtual-content data; train a machine-learning model to generate virtual content based on the plurality of sets of image data and virtual-content data; and provide the machine-learning model to an XR device, wherein the XR device is configured to use the machine-learning model to generate new virtual content.

In another example, an apparatus for XR is provided. The apparatus includes: means for obtaining, from a plurality of XR devices, a plurality of sets of image data and virtual-content data; means for training a machine-learning model to generate virtual content based on the plurality of sets of image data and virtual-content data; and means for providing the machine-learning model to an XR device, wherein the XR device is configured to use the machine-learning model to generate new virtual content.

In another example, a method is provided for XR. The method includes: obtaining position information from an XR device; selecting a machine-learning model from among a plurality of machine-learning models based on the position information; and providing the machine-learning model to the XR device, wherein the XR device is configured to use the machine-learning model to generate virtual content related to the position information.

In another example, an apparatus for XR is provided that includes at least one memory and at least one processor (e.g., configured in circuitry) coupled to the at least one memory. The at least one processor configured to: obtain position information from an XR device; select a machine-learning model from among a plurality of machine-learning models based on the position information; and provide the machine-learning model to the XR device, wherein the XR device is configured to use the machine-learning model to generate virtual content related to the position information.

In another example, a non-transitory computer-readable medium is provided that has stored thereon instructions that, when executed by one or more processors, cause the one or more processors to: obtain position information from an XR device; select a machine-learning model from among a plurality of machine-learning models based on the position information; and provide the machine-learning model to the XR device, wherein the XR device is configured to use the machine-learning model to generate virtual content related to the position information.

In another example, an apparatus for XR is provided. The apparatus includes: means for obtaining position information from an XR device; means for selecting a machine-learning model from among a plurality of machine-learning models based on the position information; and means for providing the machine-learning model to the XR device, wherein the XR device is configured to use the machine-learning model to generate virtual content related to the position information.

In another example, a method is provided for XR. The method includes: transmitting position information from an XR device to a server; receiving a machine-learning model from the server, wherein the server is configured to select the machine-learning model from among a plurality of machine-learning models based on the position information; processing image data using the machine-learning model to generate virtual content; and displaying the virtual content at a display of the XR device.

In another example, an apparatus for XR is provided that includes at least one memory and at least one processor (e.g., configured in circuitry) coupled to the at least one memory. The at least one processor configured to: transmit position information from an XR device to a server; receive a machine-learning model from the server, wherein the server is configured to select the machine-learning model from among a plurality of machine-learning models based on the position information; process image data using the machine-learning model to generate virtual content; and display the virtual content at a display of the XR device.

In another example, a non-transitory computer-readable medium is provided that has stored thereon instructions that, when executed by one or more processors, cause the one or more processors to: transmit position information from an XR device to a server; receive a machine-learning model from the server, wherein the server is configured to select the machine-learning model from among a plurality of machine-learning models based on the position information; process image data using the machine-learning model to generate virtual content; and display the virtual content at a display of the XR device.

In another example, an apparatus for XR is provided. The apparatus includes: means for transmitting position information from an XR device to a server; means for receiving a machine-learning model from the server, wherein the server is configured to select the machine-learning model from among a plurality of machine-learning models based on the position information; means for processing image data using the machine-learning model to generate virtual content; and means for displaying the virtual content at a display of the XR device.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example XR system, according to aspects of the disclosure;

FIG. 3 is a diagram illustrating yet another example XR system, according to aspects of the disclosure;

FIG. 4 is a block diagram illustrating an architecture of an example XR system, in accordance with some aspects of the disclosure;

FIG. 5 is a block diagram illustrating an architecture of a simultaneous localization and mapping (SLAM) system, according to various aspects of the present disclosure;

FIG. 6 is a block diagram of an example system for generating data, according to various aspects of the present disclosure;

FIG. 7 is an example representation of an example view that a user of an XR device may have of a scene;

FIG. 8 is a block diagram illustrating an example system for training a machine-learning model, according to various aspects of the present disclosure;

FIG. 9 is a block diagram of an example system for training a machine-learning model, according to various aspects of the present disclosure;

FIG. 10 is a block diagram of an example system for generating data, according to various aspects of the present disclosure;

FIG. 11 includes two illustrations of two respective example scenarios in which machine-learning model 1004 may generate virtual content for display, according to various aspects of the present disclosure;

FIG. 12 is a flow diagram illustrating an example process for XR, in accordance with aspects of the present disclosure;

FIG. 13 is a flow diagram illustrating an example process for XR, in accordance with aspects of the present disclosure;

FIG. 14 is a flow diagram illustrating an example process for XR, in accordance with aspects of the present disclosure;

FIG. 15 is a block diagram illustrating an example of a deep learning neural network that can be used to perform various tasks, according to some aspects of the disclosed technology;

FIG. 16 is a block diagram illustrating an example of a convolutional neural network (CNN), according to various aspects of the present disclosure;

FIG. 17 illustrates a flow diagram for an example of a method of training, using, and updating a generative adversarial network (GAN) model, in accordance with certain aspects; and

FIG. 18 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems. In the present disclosure, the terms “virtual content” and “XR content” may be used interchangeable to refer to virtual content that may be rendered for display by an XR system.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects, devices, and/or points in the physical world. For example, an XR system can use tracking information to calculate the relative pose of devices, objects, and/or points of the real-world environment in order to match the relative position and movement of the devices, objects, and/or points of the real-world environment. In some examples, the XR system can use the pose and movement of one or more devices, objects, and/or points of the real-world environment to render content relative to the real-world environment in a convincing manner. The relative pose information can be used to match virtual content with the user's perceived motion and the spatio-temporal state of the devices, objects, and/or points of the real-world environment. Matching virtual content to devices, objects, and points of the real-world environment may be referred to as “anchoring.” For example, a virtual object may be anchored to a device, object, or point of the real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

XR systems may track a pose (e.g., orientation and position) of a display of the XR system. Tracking the pose of the display may allow the XR system to display virtual content relative to the real world (e.g., to anchor virtual content to points in the real world). For example, tracking the pose of the display may allow the XR system to display virtual content within a field of view of a user such that as the user moves and/or reorients the display, the virtual content remains in the same position in the user's field of view of the real world.

In some cases, a display of an XR system (e.g., a head-mounted display (HMD), AR glasses, etc.) may include one or more inertial measurement units (IMUs) and may use measurements from the IMUs (e.g., IMU data) to track a pose of the display. For example, the XR system may assume an initial position of the display and track a position and/or orientation of the display based on acceleration measured by the IMUs. IMUs may include accelerometers, magnetometers, and/or gyroscopes (also referred to as gyroscopic sensors).

Additionally or alternatively, some XR systems may use a computational-geometry technique (e.g., a visual-odometry technique, a visual simultaneous localization and mapping (VSLAM), which may also be referred to as simultaneous localization and mapping (SLAM)) or other image-based techniques to track a pose of a display of such XR systems. In VSLAM, a device can capture images of an environment and keep track of the device's pose within the environment based on tracking where objects in the environment appear in the images, for example, as the device moves and/or reorients relative to the objects.

Degrees of freedom (DoF) refer to the number of basic ways a rigid object can move in three-dimensional (3D) space. In the context of systems that track movement through an environment, such as XR systems, degrees of freedom can refer to which of six degrees of freedom the system is capable of tracking. For example, 3DoF systems generally track the three rotational DoF-pitch, yaw, and roll. A 3DoF headset, for instance, can track the user of the headset turning their head left or right, tilting their head up or down, and/or tilting their head to the left or right. In some aspects, a 3DoF system may use IMU data from an IMU to track an orientation of a display.

6DoF systems can track the three rotational DoF as well as three translational DoF. For example, a 6DoF headset can track the user moving forward, backward, laterally, and/or vertically in addition to tracking the three rotational DoF. In some aspects, a 6DoF system may use image data from a camera (according to a computational-geometry technique) to determine a pose (e.g., orientation and position) of a display.

In the present disclosure, the term “orientation” may refer to orientation, for example, according to three rotational degrees of freedom (e.g., roll, pitch, and yaw). In the present disclosure, the term position may refer to a position, for example, according to three translational degrees of freedom (e.g., according to x, y, and z dimensions). In the present disclosure, the term “pose” may refer to a position and/or orientation. Poses may be determined according to six degrees of freedom including three translational degrees of freedom (e.g., x, y, and z dimensions) and three rotational degrees of freedom (e.g., roll, pitch, and yaw).

Generative machine-learning models (which may alternatively be referred to as generative artificial intelligence (AI)) are capable of generating data (e.g., image data, video data, text data, audio data, numerical data, etc.). For example, a generative adversarial network (GAN) may include a generator network trained to generate data and a discriminator network trained to distinguish between data generated by the generator and data including in a corpus of training data. Through the process of training, the generator may become increasingly proficient at generating data that appears similar (e.g., undistinguishable) from data in the corpus of training data. As another example, a diffusion model may be trained to generate data by iteratively adjusting initially random data until the random data is similar to training data.

In any case, generative machine-learning models may be trained to generate data based on inputs (e.g., prompts). For example, a generator of a GAN or a diffusion model may be trained to generate image data the represents something described in a textual prompt.

Systems, apparatuses, methods (also referred to as processes), and computer-readable media (collectively referred to herein as “systems and techniques”) are described herein for generating virtual content for display. For example, the systems and techniques described herein may use a generative machine-learning model to generate virtual content for display by an XR device.

For instance, the systems and techniques may use generative a machine-learning model to generate XR-based indications/overlays for users based on the context, location, orientation, and nature of the environment. Such models can be applied to tourism, shopping, navigation, etc. As an example, a tourist exploring a certain neighborhood may be shown virtual content that highlights points-of-interest, that were also shown to previous tourists in the area.

In some aspects, the systems and techniques may use real-world measurements (e.g., images and/or location determinations), such as from camera and radio-frequency (RF) technologies, as input to training machine-learning models to generate virtual content that is relevant to environments related to the real-world measurements. For example, the systems and techniques may obtain, from a plurality of XR devices, a plurality of sets of image data and virtual-content data. The systems and techniques may train a machine-learning model to generate virtual content based on the plurality of sets of image data and virtual-content data. Further the systems and techniques may provide the machine-learning model to an XR device such that the XR device may use the machine-learning model to generate new virtual content.

Additionally or alternatively, the systems and techniques may select a model based on an environment of an XR device and provide the selected model to the XR device such that the XR device can use the model to generate virtual content relevant to the environment of the XR device. For example, the systems and techniques may obtain position information from an XR device. The systems and techniques may select a machine-learning model from among a plurality of machine-learning models available at to the systems and techniques based on the position information. Further the systems and techniques may provide the machine-learning model to an XR device such that the XR device can use the machine-learning model to generate virtual content related to the position information.

For instance, the systems and techniques may obtain images of a location captured by a plurality of XR devices in the location. Additionally, the systems and techniques may obtain virtual content displayed by the plurality of XR devices at the time the images were captured. The systems and techniques may use the images and virtual content as training data to train a machine-learning model to generate virtual content similar to the training virtual content based on input images similar to the training image data.

Then, the systems and techniques may deploy the trained machine-learning model to an XR device. For example, an XR device may report its position to a server. The server may identify a machine-learning model trained using data related to the position and transmit the identified machine-learning model to the XR device. When the device is in the environment (or a similar environment), captures images in the environment, and provides the images to the machine-learning model as input, the machine-learning model may generate virtual content that is similar to the training virtual content.

In some aspects, the machine-learning model may be trained specific to generate virtual content related to a specific location (e.g., a specific latitude and longitude). In other aspect, the machine-learning model may be trained to generate data based on a class of location (e.g., a grocery stores, parks, airports, forests, etc.). Additionally or alternatively, the machine-learning model may be trained specific to a class of venue (e.g., a chain of retail locations such that an XR device may run a model specific to the chain of retail locations whenever the XR device is in any of the chain of retail locations.

Various aspects of the application will be described with respect to the figures below.

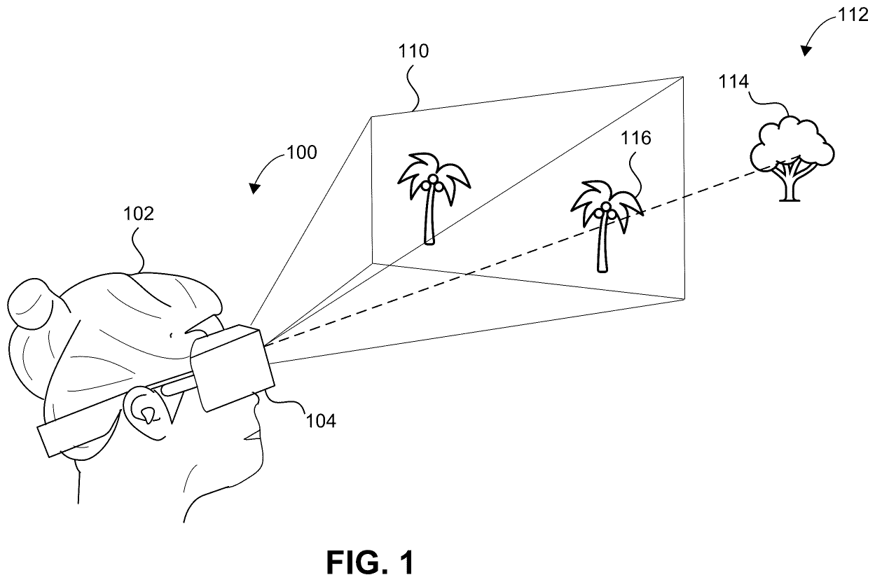

FIG. 1 is a diagram illustrating an example extended-reality (XR) system 100, according to aspects of the disclosure. As shown, XR system 100 includes an XR device 104. XR device 104 may implement, as examples, image-capture, object-detection, object-tracking, gaze-tracking, view-tracking, localization (e.g., determining a location of XR device 104), pose-tracking (e.g., tracking a pose of XR device 104), content-generation, content-rendering, computational, communicational, and/or display aspects of extended reality, including virtual reality (VR), augmented reality (AR), and/or mixed reality (MR).

For example, XR device 104 may include one or more scene-facing cameras that may capture images of a scene 112 in which a user 102 uses XR device 104. XR device 104 may detect objects (e.g., object 114) in scene 112 based on the images of scene 112. In some aspects, XR device 104 may include one or more user-facing cameras that may capture images of eyes of user 102. XR device 104 may determine a gaze of user 102 based on the images of user 102. In some aspects, XR device 104 may determine an object of interest (e.g., object 114) in scene 112 (e.g., based on the gaze of user 102, based on object recognition, and/or based on a received indication regarding object 114). XR device 104 may obtain and/or render XR content 116 (e.g., text, images, and/or video) for display at XR device 104. XR device 104 may display XR content 116 to user 102 (e.g., within a field of view 110 of user 102). In some aspects, XR content 116 may be based on the object of interest. For example, XR content 116 may be an altered version of object 114. As another example, XR content 116 may appear to interact with object 114. For example, object 114 may be a tree and XR content 116 may include a monkey climbing the tree.

In some aspects, XR device 104 may display XR content 116 in relation to the view of user 102 of the object of interest. For example, XR device 104 may overlay XR content 116 onto object 114 in field of view 110. In any case, XR device 104 may overlay XR content 116 (whether related to object 114 or not) onto the view of user 102 of scene 112. XR device 104 may anchor XR content 116 to object 114, for example, such that as user 102 moves their head (e.g., changing field of view 110), XR content 116 remains in the line of sight between the eyes of user 102 and object 114. To do this, XR device 104 may track a pose of XR device 104 (e.g., based on movement data from one or more inertial measurement units (IMUs) of XR device 104.

In a “see-through” configuration, XR device 104 may include a transparent surface (e.g., optical glass) such that XR content 116 may be displayed on (e.g., by being projected onto) the transparent surface to overlay the view of user 102 of scene 112 as viewed through the transparent surface. In a “pass-through” configuration or a “video see-through” (VST) configuration, XR device 104 may include a scene-facing camera that may capture images of scene 112. XR device 104 may display images or video of scene 112, as captured by the scene-facing camera, and XR content 116 overlaid on the images or video of scene 112.

In various examples, XR device 104 may be, or may include, a head-mounted device (HMD), a virtual reality headset, and/or smart glasses. XR device 104 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, displays, and/or smart glass).

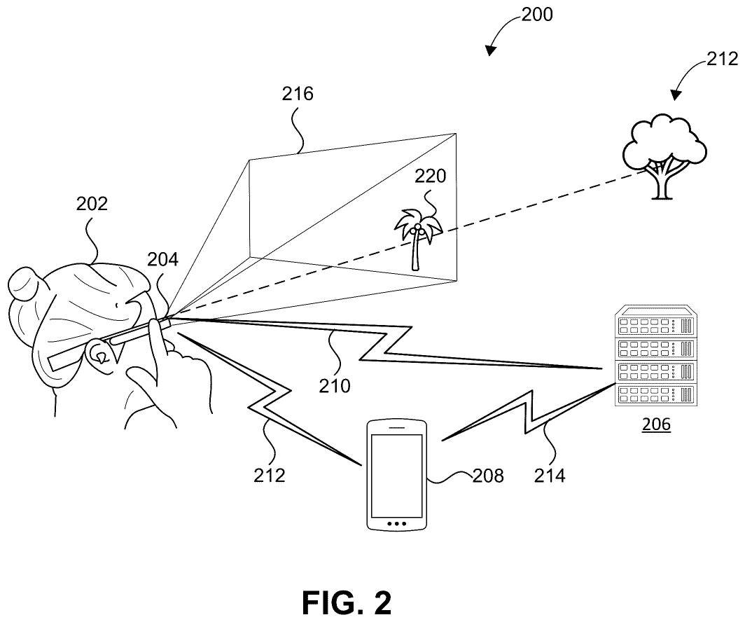

FIG. 2 is a diagram illustrating an example extended reality (XR) system 200, according to aspects of the disclosure. In some aspects, an XR system may be, or may include, two or more devices. The two or more devices of XR system 200 may perform the operations described with regard to XR system 100 of FIG. 1.

For example, XR system 200 includes a display device 204 and a processing device 206. In some aspects, display device 204 and processing device 206 may implement a communication link 210 between display device 204 and processing device 206. Communication link 210 may be a wireless connection according to any suitable wireless protocol, such as, a broadband-cellular-network protocol, for example, a fifth generation (5G) wireless cellular protocol.

In other aspects, XR system 200 may include a companion device 208. Display device 204 and companion device 208 and may implement a communication link 212 between display device 204 and companion device 208 and companion device 208 and processing device 206 may implement a communication link 214 between companion device 208 and processing device 206. Communication link 212 may be a wireless connection according to any suitable wireless protocol, such as, for example, Institute of Electrical and Electronics Engineers (IEEE) 802.11 (Wi-Fi), IEEE 802.15, or Bluetooth®. Communication link 214 may be a wireless connection according to any suitable wireless protocol, such as, a broadband-cellular-network protocol, for example, a fifth generation (5G) wireless cellular protocol.

Display device 204, processing device 206, and/or companion device 208 may collectively implement as examples, image-capture, object-detection, object-tracking, gaze-tracking, view-tracking, localization, pose-tracking, content-generation, content-rendering, computational, communicational, and/or display aspects of XR. For example, display device 204 may implement image-capture, gaze-tracking, view-tracking, localization, pose-tracking, communicational, and/or display aspects of XR. Processing device 206 may implement object-detection, object-tracking, localization, content-generation, content-rendering, computational, and/or communicational, aspects of XR. Additionally or alternatively, companion device 208 may implement at least a portion of one or more of localization, pose-tracking, communicational, object-detection, object-tracking, localization, content-generation, content-rendering, and/or computational aspects of XR.

For example, display device 204 may capture and/or generate data, such as image data (e.g., from user-facing cameras and/or scene-facing cameras) and/or motion data (from an inertial measurement unit (IMU)). Display device 204 may provide the data to processing device 206, for example, through communication link 210 or through communication link 212, companion device 208, and communication link 214.

Processing device 206 may process the data and/or other data (e.g., data received from another source or data stored at processing device 206). For example, processing device 206 may detect, recognize, and/or track objects in scene 218 based on the images of scene 218. Further, processing device 206 may generate (or obtain) XR content 220 to be rendered for display at display device 204. Processing device 206 may render XR content 220 to be appropriate for display at display device 204 (e.g., based on a pose of display device 204). Processing device 206 may provide rendered XR content 220 to display device 204 through communication link 210 (or communication link 214, companion device 208, and communication link 212) and display device 204 may display XR content 220 in field of view 216 of user 202.

In various examples, display device 204 may be, or may include, a head-mounted display (HMD), a virtual reality headset, and/or smart glasses. Display device 204 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, headphones, displays, and/or smart glass).

Processing device 206 may be, or may include, for example, a server computer (e.g., an edge or cloud-based server, a personal computer acting as a server device, or a mobile device acting as a server device). Processing device 206 may be configured to store virtual content and/or perform operations related to rendering the virtual content as image data suitable for providing to display device 204 for display.

Companion device 208 may be, or may include, a smartphone, laptop, tablet computer, personal computer, gaming system, any other computing device and/or a combination thereof.

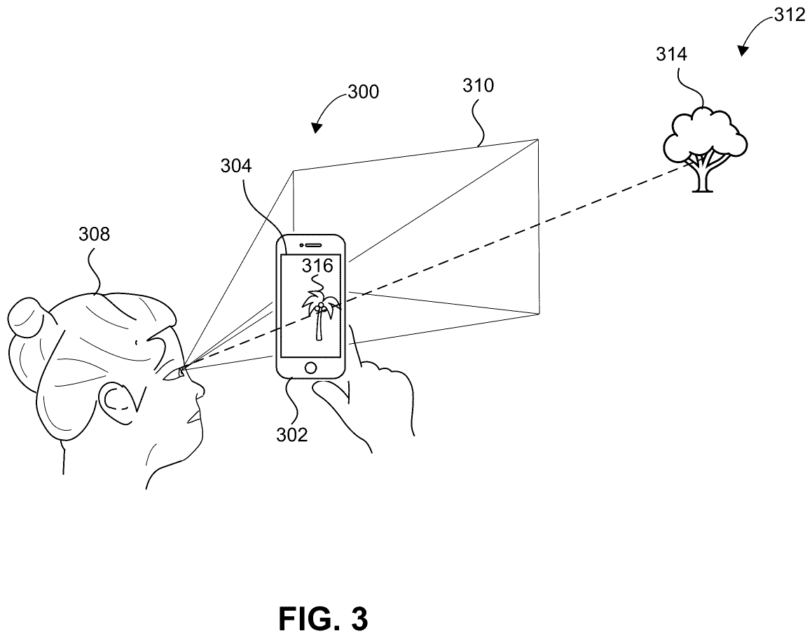

FIG. 3 is a diagram illustrating an example extended-reality (XR) system 300, according to aspects of the disclosure. As shown, XR system 300 includes an XR device 302 including a display 304. In some cases, XR device 302 may implement, as examples, image-capture, object-detection, object-tracking, gaze-tracking, view-tracking, localization, pose-tracking, content-generation, content-rendering, computational, communicational, and/or display aspects of XR.

For example, XR device 302 may include one or more scene-facing cameras that may capture images of a scene 312 in which a user 308 uses XR device 302. XR device 302 may detect objects (e.g., object 314) in scene 312 based on the images of scene 312. In some aspects, XR device 302 may include one or more user-facing cameras that may capture images of eyes of user 308. XR device 302 may determine a gaze of user 308 and/or a field of view 310 of user 308 based on the images of user 102. In some aspects, XR device 302 may determine an object of interest (e.g., object 314) in scene 312 (e.g., based on the gaze of user 308, based on object recognition, and/or based on a received indication regarding object 314). XR device 302 may obtain and/or render XR content 316 (e.g., text, images, and/or video) for display at display 304. XR device 302 may display XR content 316 to user 308 (e.g., within a field of view 310 of user 308). In some aspects, XR device 302 may determine a position of display 304 relative to field of view 310 of user 308 and scene 312. XR device 302 may track the pose of XR device 302 relative to user 308, field of view 310, and scene 312 such that XR content 316 aligns in field of view 310 of user 308 with scene 312. In some aspects, XR device 302 may capture images at a scene-facing camera and display the images at display 304 (e.g., without tracking field of view 310). XR device 302 may overlay XR content 316 onto the images captured by the scene-facing camera and displayed at display 304.

In some aspects, XR content 316 may be based on the object of interest. For example, XR content 316 may be an altered version of object 314. In some aspects, XR device 302 may display XR content 316 in relation to the view of user 308 of the object of interest. For example, XR device 302 may overlay XR content 316 onto object 314 in field of view 310. In any case, XR device 302 may overlay XR content 316 (whether related to object 314 or not) onto the view of user 308 of scene 312.

XR device 302 may operate in in a “pass-through” configuration or a “video see-through” configuration. For example, XR device 302 may include a scene-facing camera that may capture images of the scene of user 308. XR device 302 may display images or video of the scene, as captured by the scene-facing camera, and overlay XR content 316 onto the images or video of the scene. XR device 302 may display the information to be viewed by user 308 in field of view 310 of user 308. In a “see-through” configuration, XR device 302 may include a transparent surface (e.g., optical glass) such that information may be displayed on the transparent surface to overlay the information onto the scene as viewed through the transparent surface.

XR device 302 and/or display 304 may be, or may include, a handheld device, a smartphone, a tablet, or another computing device with a display. XR device 302 include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass).

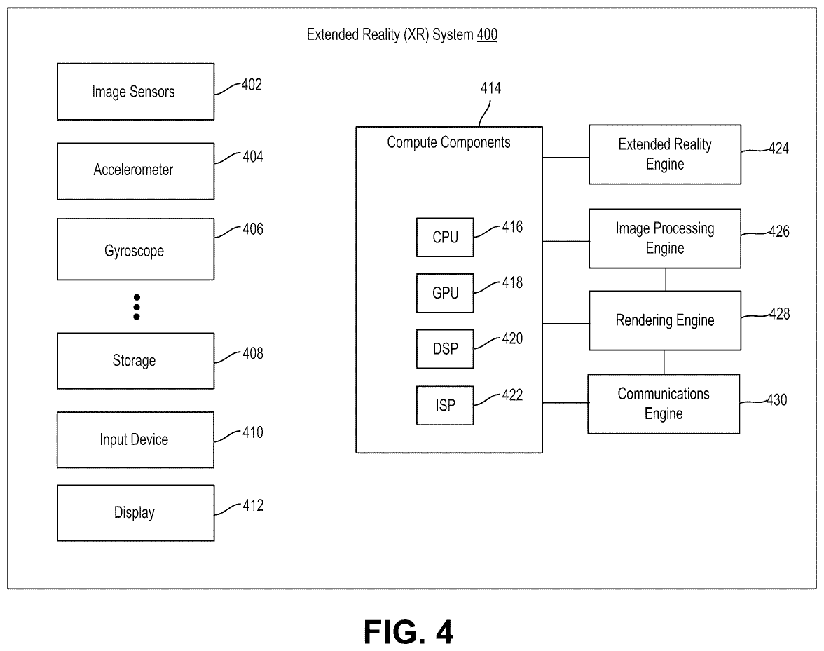

FIG. 4 is a diagram illustrating an architecture of an example extended reality (XR) system 400, in accordance with some aspects of the disclosure. XR system 400 may execute XR applications and implement XR operations. XR system 400 may be an example of, or be included in, any of XR device 104 of FIG. 1, display device 204 and/or companion device 208 of FIG. 2, and/or XR device 302 of FIG. 3.

In this illustrative example, XR system 400 includes one or more image sensors 402, an accelerometer 404, a gyroscope 406, storage 408, an input device 410, a display 412, Compute components 414, an XR engine 426, an image processing engine 428, a rendering engine 430, and a communications engine 432. It should be noted that the components 402-432 shown in FIG. 4 are non-limiting examples provided for illustrative and explanation purposes, and other examples may include more, fewer, or different components than those shown in FIG. 4. For example, in some cases, XR system 400 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 4. While various components of XR system 400, such as image sensor 402, may be referenced in the singular form herein, it should be understood that XR system 400 may include multiple of any component discussed herein (e.g., multiple image sensors 402).

Display 412 may be, or may include, a glass, a screen, a lens, a projector, and/or other display mechanism that allows a user to see the real-world environment and also allows XR content to be overlaid, overlapped, blended with, or otherwise displayed thereon.

XR system 400 may include, or may be in communication with, (wired or wirelessly) an input device 410. Input device 410 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 402 may capture images that may be processed for interpreting gesture commands.

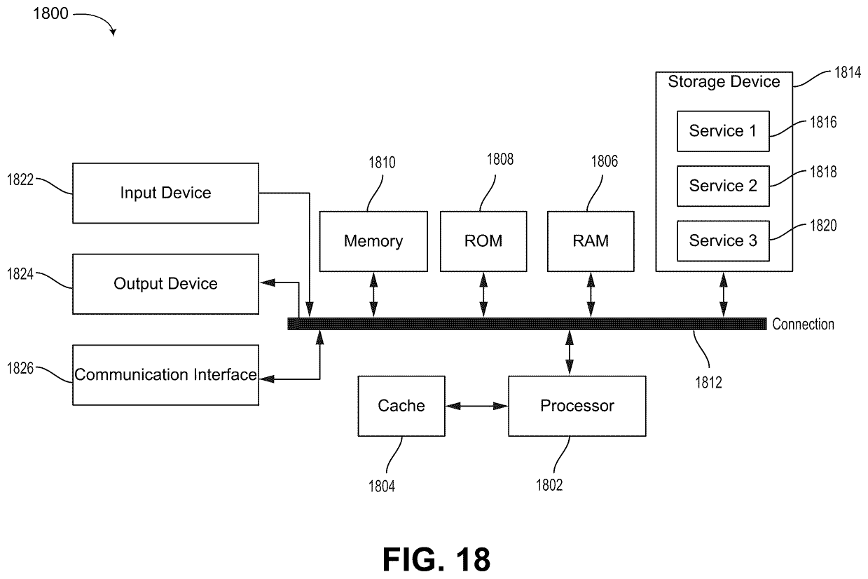

XR system 400 may also communicate with one or more other electronic devices (wired or wirelessly). For example, communications engine 432 may be configured to manage connections and communicate with one or more electronic devices. In some cases, communications engine 432 may correspond to communication interface 1826 of FIG. 18.

In some implementations, image sensors 402, accelerometer 404, gyroscope 406, storage 408, display 412, compute components 414, XR engine 426, image processing engine 428, and rendering engine 430 may be part of the same computing device. For example, in some cases, image sensors 402, accelerometer 404, gyroscope 406, storage 408, display 412, compute components 414, XR engine 426, image processing engine 428, and rendering engine 430 may be integrated into an HMD, extended reality glasses, smartphone, laptop, tablet computer, gaming system, and/or any other computing device. However, in some implementations, image sensors 402, accelerometer 404, gyroscope 406, storage 408, display 412, compute components 414, XR engine 426, image processing engine 428, and rendering engine 430 may be part of two or more separate computing devices. For instance, in some cases, some of the components 402-432 may be part of, or implemented by, one computing device and the remaining components may be part of, or implemented by, one or more other computing devices. For example, such as in a split perception XR system, XR system 400 may include a first device (e.g., an HMD), including display 412, image sensor 402, accelerometer 404, gyroscope 406, and/or one or more compute components 414. XR system 400 may also include a second device including additional compute components 414 (e.g., implementing XR engine 426, image processing engine 428, rendering engine 430, and/or communications engine 432). In such an example, the second device may generate virtual content based on information or data (e.g., images, sensor data such as measurements from accelerometer 404 and gyroscope 406) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 408 may be any storage device(s) for storing data. Moreover, storage 408 may store data from any of the components of XR system 400. For example, storage 408 may store data from image sensor 402 (e.g., image or video data), data from accelerometer 404 (e.g., measurements), data from gyroscope 406 (e.g., measurements), data from compute components 414 (e.g., processing parameters, preferences, virtual content, rendering content, scene maps, tracking and localization data, object detection data, privacy data, XR application data, face recognition data, occlusion data, etc.), data from XR engine 426, data from image processing engine 428, and/or data from rendering engine 430 (e.g., output frames). In some examples, storage 408 may include a buffer for storing frames for processing by compute components 414.

Compute components 414 may be, or may include, a central processing unit (CPU) 416, a graphics processing unit (GPU) 418, a digital signal processor (DSP) 420, an image signal processor (ISP) 422, a neural processing unit (NPU) 424, which may implement one or more trained neural networks, and/or other processors. Compute components 414 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 414 may implement (e.g., control, operate, etc.) XR engine 426, image processing engine 428, and rendering engine 430. In other examples, compute components 414 may also implement one or more other processing engines.

Image sensor 402 may include any image and/or video sensors or capturing devices. In some examples, image sensor 402 may be part of a multiple-camera assembly, such as a dual-camera assembly. Image sensor 402 may capture image and/or video content (e.g., raw image and/or video data), which may then be processed by compute components 414, XR engine 426, image processing engine 428, and/or rendering engine 430 as described herein.

In some examples, image sensor 402 may capture image data and may generate images (also referred to as frames) based on the image data and/or may provide the image data or frames to XR engine 426, image processing engine 428, and/or rendering engine 430 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 402 (and/or other camera of XR system 400) may be configured to also capture depth information. For example, in some implementations, image sensor 402 (and/or other camera) may include an RGB-depth (RGB-D) camera. In some cases, XR system 400 may include one or more depth sensors (not shown) that are separate from image sensor 402 (and/or other camera) and that may capture depth information. For instance, such a depth sensor may obtain depth information independently from image sensor 402. In some examples, a depth sensor may be physically installed in the same general location or position as image sensor 402 but may operate at a different frequency or frame rate from image sensor 402. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 400 may also include other sensors in its one or more sensors. The one or more sensors may include one or more accelerometers (e.g., accelerometer 404), one or more gyroscopes (e.g., gyroscope 406), and/or other sensors. The one or more sensors may provide velocity, orientation, and/or other position-related information to compute components 414. For example, accelerometer 404 may detect acceleration by XR system 400 and may generate acceleration measurements based on the detected acceleration. In some cases, accelerometer 404 may provide one or more translational vectors (e.g., up/down, left/right, forward/back) that may be used for determining a position or pose of XR system 400. Gyroscope 406 may detect and measure the orientation and angular velocity of XR system 400. For example, gyroscope 406 may be used to measure the pitch, roll, and yaw of XR system 400. In some cases, gyroscope 406 may provide one or more rotational vectors (e.g., pitch, yaw, roll). In some examples, image sensor 402 and/or XR engine 426 may use measurements obtained by accelerometer 404 (e.g., one or more translational vectors) and/or gyroscope 406 (e.g., one or more rotational vectors) to calculate the pose of XR system 400. As previously noted, in other examples, XR system 400 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 400, using a combination of one or more accelerometers, one or more gyroscopes, and/or one or more magnetometers. In some examples, the one or more sensors may output measured information associated with the capture of an image captured by image sensor 402 (and/or other camera of XR system 400) and/or depth information obtained using one or more depth sensors of XR system 400.

The output of one or more sensors (e.g., accelerometer 404, gyroscope 406, one or more IMUs, and/or other sensors) can be used by XR engine 426 to determine a pose of XR system 400 (also referred to as the head pose) and/or the pose of image sensor 402 (or other camera of XR system 400). In some cases, the pose of XR system 400 and the pose of image sensor 402 (or other camera) can be the same. The pose of image sensor 402 refers to the position and orientation of image sensor 402 relative to a frame of reference (e.g., with respect to a field of view 110 of FIG. 1). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 402 to track a pose (e.g., a 6DoF pose) of XR system 400. For example, the device tracker can fuse visual data (e.g., using a visual tracking solution) from the image data with inertial data from the measurements to determine a position and motion of XR system 400 relative to the physical world (e.g., the scene) and a map of the physical world. As described below, in some examples, when tracking the pose of XR system 400, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 400 within the scene and the 3D map of the scene, etc. The 3D map can provide a digital representation of a scene in the real/physical world. In some examples, the 3D map can anchor position-based objects and/or content to real-world coordinates and/or objects. XR system 400 can use a mapped scene (e.g., a scene in the physical world represented by, and/or associated with, a 3D map) to merge the physical and virtual worlds and/or merge virtual content or objects with the physical environment.

In some aspects, the pose of image sensor 402 and/or XR system 400 as a whole can be determined and/or tracked by compute components 414 using a visual tracking solution based on images captured by image sensor 402 (and/or other camera of XR system 400). For instance, in some examples, compute components 414 can perform tracking using computer vision-based tracking, model-based tracking, and/or simultaneous localization and mapping (SLAM) techniques. For instance, compute components 414 can perform SLAM or can be in communication (wired or wireless) with a SLAM system (not shown). SLAM refers to a class of techniques where a map of an environment (e.g., a map of an environment being modeled by XR system 400) is created while simultaneously tracking the pose of a camera (e.g., image sensor 402) and/or XR system 400 relative to that map. The map can be referred to as a SLAM map and can be three-dimensional (3D). The SLAM techniques can be performed using color or grayscale image data captured by image sensor 402 (and/or other camera of XR system 400) and can be used to generate estimates of 6DoF pose measurements of image sensor 402 and/or XR system 400. Such a SLAM technique configured to perform 6DoF tracking can be referred to as 6DoF SLAM. In some cases, the output of the one or more sensors (e.g., accelerometer 404, gyroscope 406, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 402 (and/or other camera) to the SLAM map. For example, 6DoF SLAM can use feature point associations from an input image to determine the pose (position and orientation) of the image sensor 402 and/or XR system 400 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 402 and/or the XR system 400 can be determined by projecting features from the 3D SLAM map into an image or video frame and updating the camera pose from verified 2D-3D correspondences.

In one illustrative example, the compute components 414 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 414 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 400 can also track the hand and/or fingers of the user to allow the user to interact with and/or control virtual content in a virtual environment. For example, the XR system 400 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

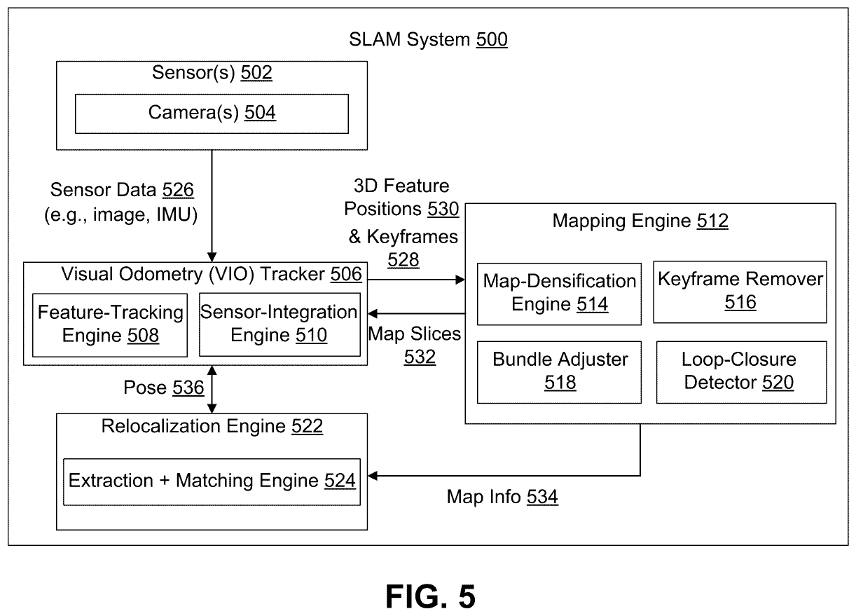

FIG. 5 is a block diagram illustrating an architecture of a simultaneous localization and mapping (SLAM) system 500, according to various aspects of the present disclosure. In some aspects, SLAM system 500 can be, or can include, a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

SLAM system 500 of FIG. 5 includes, or is coupled to, one or more sensor(s) 502. Sensor(s) 502 can include one or more camera(s) 504. Each of camera(s) 504 may be responsive to light from a particular spectrum of light. The spectrum of light may be a subset of the electromagnetic (EM) spectrum. For example, each of camera(s) 504 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or any combination thereof.

Sensor(s) 502 can include one or more other types of sensors other than camera(s) 504, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof.

SLAM system 500 includes a visual-inertial odometry (VIO) tracker 506. The term visual-inertial odometry may also be referred to herein as visual odometry. VIO tracker 506 receives sensor data 526 from sensor(s) 502. For instance, sensor data 526 can include one or more images captured by camera(s) 504. Sensor data 526 can include other types of sensor data from camera(s) 504, such as data from any of the types of camera(s) 504 listed herein. For instance, sensor data 526 can include inertial measurement unit (IMU) data from one or more IMUs of camera(s) 504.

Upon receipt of sensor data 526 from sensor(s) 502, VIO tracker 506 performs feature detection, extraction, and/or tracking using a feature-tracking engine 508 of VIO tracker 506. For instance, where sensor data 526 includes one or more images captured by camera(s) 504 of SLAM system 500, VIO tracker 506 can identify, detect, and/or extract features in each image. Features may include visually distinctive points in an image, such as portions of the image depicting edges and/or corners. VIO tracker 506 can receive sensor data 526 periodically and/or continually from sensor(s) 502, for instance by continuing to receive more images from camera(s) 504 as camera(s) 504 capture a video, where the images are video frames of the video. VIO tracker 506 can generate descriptors for the features. Feature descriptors can be generated at least in part by generating a description of the feature as depicted in a local image patch extracted around the feature. In some examples, a feature descriptor can describe a feature as a collection of one or more feature vectors. VIO tracker 506, in some cases with mapping engine 512 and/or relocalization engine 522, can associate the plurality of features with a map of the environment based on such feature descriptors. Feature-tracking engine 508 of VIO tracker 506 can perform feature tracking by recognizing features in each image that VIO tracker 506 already previously recognized in one or more previous images, in some cases based on identifying features with matching feature descriptors in different images. Feature-tracking engine 508 can track changes in one or more positions at which the feature is depicted in each of the different images. For example, the feature extraction engine can detect a particular corner of a room depicted in a left side of a first image captured by a first camera of camera(s) 504. Feature-tracking engine 508 can detect the same feature (e.g., the same particular corner of the same room) depicted in a right side of a second image captured by the first camera. Feature-tracking engine 508 can recognize that the features detected in the first image and the second image are two depictions of the same feature (e.g., the same particular corner of the same room), and that the feature appears in two different positions in the two images. VIO tracker 506 can determine, based on the same feature appearing on the left side of the first image and on the right side of the second image that the first camera has moved, for example if the feature (e.g., the particular corner of the room) depicts a static portion of the environment.

VIO tracker 506 can include a sensor-integration engine 510. Sensor-integration engine 510 can use sensor data from other types of sensor(s) 502 (other than camera(s) 504) to determine information that can be used by feature-tracking engine 508 when performing the feature tracking. For example, sensor-integration engine 510 can receive IMU data (e.g., which can be included as part of sensor data 526) from an IMU of sensor(s) 502. Sensor-integration engine 510 can determine, based on the IMU data in sensor data 526, that SLAM system 500 has rotated 15 degrees in a clockwise direction from acquisition or capture of a first image and capture to acquisition or capture of the second image by a first camera of camera(s) 504. Based on this determination, sensor-integration engine 510 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). Feature-tracking engine 508 can take this expectation into consideration in tracking features between the first image and the second image.

Based on the feature tracking by feature-tracking engine 508 and/or the sensor integration by sensor-integration engine 510, VIO tracker 506 can determine 3D feature positions 530 of a particular feature. 3D feature positions 530 can include one or more 3D feature positions and can also be referred to as 3D feature points. 3D feature positions 530 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. VIO tracker 506 can also determine one or more keyframes 528 (referred to hereinafter as keyframes 528) corresponding to the particular feature. A keyframe (from one or more keyframes 528) corresponding to a particular feature may be an image in which the particular feature is clearly depicted. In some examples, a keyframe (from the one or more keyframes 528) corresponding to a particular feature may be an image in which the particular feature is clearly depicted. In some examples, a keyframe corresponding to a particular feature may be an image that reduces uncertainty in 3D feature positions 530 of the particular feature when considered by feature-tracking engine 508 and/or sensor-integration engine 510 for determination of 3D feature positions 530. In some examples, a keyframe corresponding to a particular feature also includes data associated with pose 536 of SLAM system 500 and/or camera(s) 504 during capture of the keyframe. In some examples, VIO tracker 506 can send 3D feature positions 530 and/or keyframes 528 corresponding to one or more features to mapping engine 512. In some examples, VIO tracker 506 can receive map slices 532 from mapping engine 512. VIO tracker 506 can feature information within map slices 532 for feature tracking using feature-tracking engine 508.

Based on the feature tracking by feature-tracking engine 508 and/or the sensor integration by sensor-integration engine 510, VIO tracker 506 can determine a pose 536 of SLAM system 500 and/or of camera(s) 504 during capture of each of the images in sensor data 526. Pose 536 can include a location of SLAM system 500 and/or of camera(s) 504 in 3D space, such as a set of coordinates along three different axes that are perpendicular to one another (e.g., an X coordinate, a Y coordinate, and a Z coordinate). Pose 536 can include an orientation of SLAM system 500 and/or of camera(s) 504 in 3D space, such as pitch, roll, yaw, or some combination thereof. In some examples, VIO tracker 506 can send pose 536 to relocalization engine 522. In some examples, VIO tracker 506 can receive pose 536 from relocalization engine 522.

SLAM system 500 also includes a mapping engine 512. Mapping engine 512 generates a 3D map of the environment based on 3D feature positions 530 and/or keyframes 528 received from VIO tracker 506. Mapping engine 512 can include a map-densification engine 514, a keyframe remover 516, a bundle adjuster 518, and/or a loop-closure detector 520. Map-densification engine 514 can perform map densification, in some examples, increase the quantity and/or density of 3D coordinates describing the map geometry. Keyframe remover 516 can remove keyframes, and/or in some cases add keyframes. In some examples, keyframe remover 516 can remove keyframes 528 corresponding to a region of the map that is to be updated and/or whose corresponding confidence values are low. Bundle adjuster 518 can, in some examples, refine the 3D coordinates describing the scene geometry, parameters of relative motion, and/or optical characteristics of the image sensor used to generate the frames, according to an optimality criterion involving the corresponding image projections of all points. Loop-closure detector 520 can recognize when SLAM system 500 has returned to a previously mapped region and can use such information to update a map slice and/or reduce the uncertainty in certain 3D feature points or other points in the map geometry. Mapping engine 512 can output map slices 532 to VIO tracker 506. Map slices 532 can represent 3D portions or subsets of the map. Map slices 532 can include map slices 532 that represent new, previously-unmapped areas of the map. Map slices 532 can include map slices 532 that represent updates (or modifications or revisions) to previously-mapped areas of the map. Mapping engine 512 can output map information 534 to relocalization engine 522. Map information 534 can include at least a portion of the map generated by mapping engine 512. Map information 534 can include one or more 3D points making up the geometry of the map, such as one or more 3D feature positions 530. Map information 534 can include one or more keyframes 528 corresponding to certain features and certain 3D feature positions 530.

SLAM system 500 also includes a relocalization engine 522. Relocalization engine 522 can perform relocalization, for instance when VIO tracker 506 fail to recognize more than a threshold number of features in an image, and/or VIO tracker 506 loses track of pose 536 of SLAM system 500 within the map generated by mapping engine 512. Relocalization engine 522 can perform relocalization by performing extraction and matching using an extraction and matching engine 524. For instance, extraction and matching engine 524 can by extract features from an image captured by camera(s) 504 of SLAM system 500 while SLAM system 500 is at a current pose 536, and can match the extracted features to features depicted in different keyframes 528, identified by 3D feature positions 530, and/or identified in map information 534. By matching these extracted features to the previously-identified features, relocalization engine 522 can identify that pose 536 of SLAM system 500 is a pose 536 at which the previously-identified features are visible to camera(s) 504 of SLAM system 500, and is therefore similar to one or more previous poses 536 at which the previously-identified features were visible to camera(s) 504. In some cases, relocalization engine 522 can perform relocalization based on wide baseline mapping, or a distance between a current camera position and camera position at which feature was originally captured. Relocalization engine 522 can receive information for pose 536 from VIO tracker 506, for instance regarding one or more recent poses of SLAM system 500 and/or camera(s) 504 which relocalization engine 522 can base its relocalization determination on. Once relocalization engine 522 relocates SLAM system 500 and/or camera(s) 504 and thus determines pose 536, relocalization engine 522 can output pose 536 to VIO tracker 506.

In some examples, VIO tracker 506 can modify the image in sensor data 526 before performing feature detection, extraction, and/or tracking on the modified image. For example, VIO tracker 506 can rescale and/or resample the image. In some examples, rescaling and/or resampling the image can include downscaling, downsampling, subscaling, and/or subsampling the image one or more times. In some examples, VIO tracker 506 modifying the image can include converting the image from color to greyscale, or from color to black and white, for instance by desaturating color in the image, stripping out certain color channel(s), decreasing color depth in the image, replacing colors in the image, or a combination thereof. In some examples, VIO tracker 506 modifying the image can include VIO tracker 506 masking certain regions of the image. Dynamic objects can include objects that can have a changed appearance between one image and another. For example, dynamic objects can be objects that move within the environment, such as people, vehicles, or animals. A dynamic object can be an object that have a changing appearance at different times, such as a display screen that may display different things at different times. A dynamic object can be an object that has a changing appearance based on the pose of camera(s) 504, such as a reflective surface, a prism, or a specular surface that reflects, refracts, and/or scatters light in different ways depending on the position of camera(s) 504 relative to the dynamic object. VIO tracker 506 can detect the dynamic objects using facial detection, facial recognition, facial tracking, object detection, object recognition, object tracking, or a combination thereof. VIO tracker 506 can detect the dynamic objects using one or more artificial intelligence algorithms, one or more trained machine learning models, one or more trained neural networks, or a combination thereof. VIO tracker 506 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

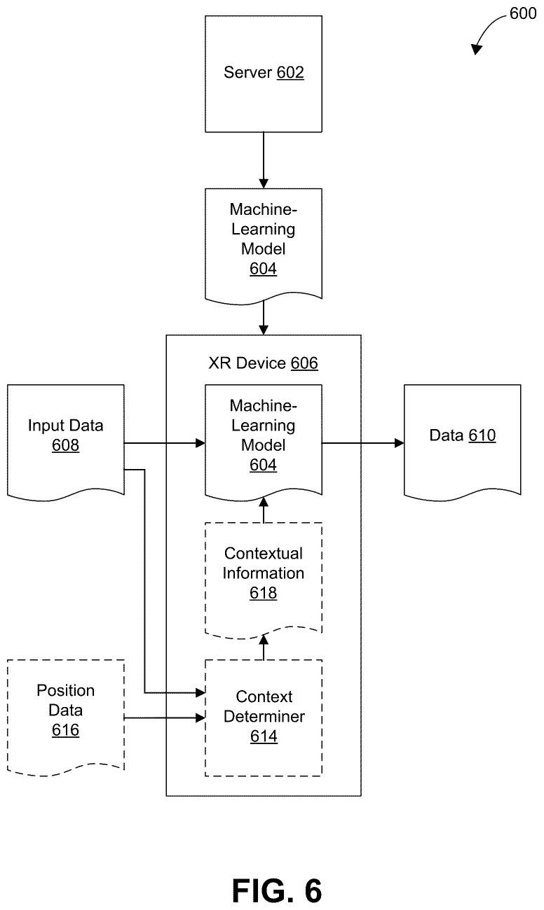

FIG. 6 is a block diagram of an example system 600 for generating data 610, according to various aspects of the present disclosure. In general, server 602 may provide machine-learning model 604 to XR device 606 and XR device 606 may use machine-learning model 1004 to process input data 608 to generate data 610.

Server 602 may be, or may include, any suitable computing device or any number of suitable computing devices. Server 602 may store machine-learning model 604. Server 602 may provide (e.g., transmit through a wired or wireless network) machine-learning model 604 to XR device 606.

Machine-learning model 604 may be a generative machine-learning model, according to various aspects of the present disclosure. In some aspects, machine-learning model 604 may include a generator of a GAN. Machine-learning model 604 may be trained, according to various aspects of the present disclosure, to generate data (e.g., image data to be displayed at an XR device) based on input data (e.g., image data from a scene-facing camera of the XR device).

XR device 606 may be, or may include, an XR device capable of running machine-learning model 604 at inference. XR device 606 may be an example of XR device 104 of FIG. 1, display device 204, processing device 206, and/or companion device 208 of FIG. 2, XR device 302 of FIG. 3, and/or XR system 400 of FIG. 4.

Input data 608 may be, or may include, image data, for example, captured by a scene-facing camera of XR device 606. For example, the scene-facing camera of XR device 606 may capture (e.g., continually at a frame-capture rate) images of an environment in which XR device 606 is used.

XR device 606 may process input data 608 using machine-learning model 604 to generate data 610. Data 610 may be, or may include, image data (e.g., rendered virtual content) to display at a display of data 610. Data 610 may include data indicating a display position for the image data (e.g., to cause the rendered virtual content to be displayed in a user's line of sight to a given point in the environment).

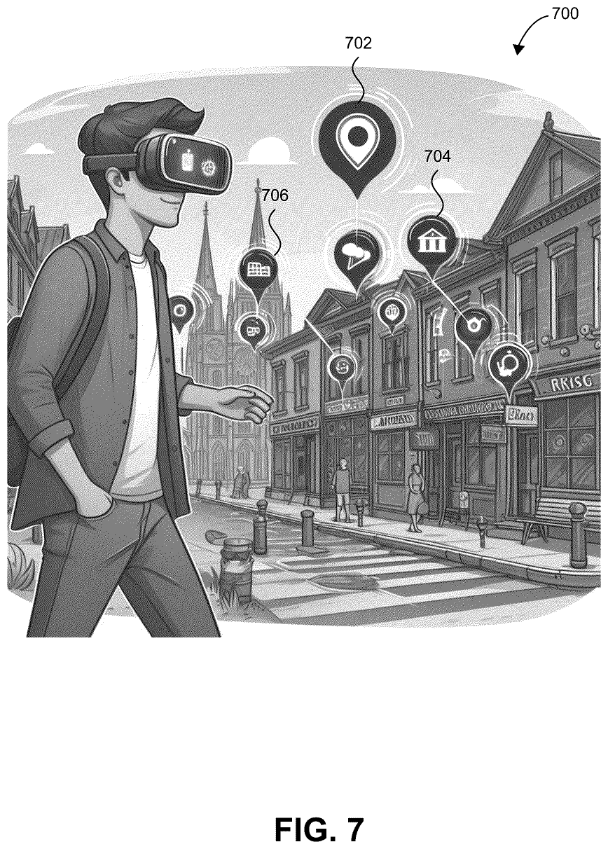

FIG. 7 is an example representation of an example view 700 that a user of an XR device (e.g., XR device 606) may have of a scene. For example, the user may observe real-world objects in the scene (such as people, buildings, the street, etc.). Additionally, XR device 606 may render XR content and display image data representative of the XR content to the user. XR device 606 may include a see-through display or may implement video-see through. In any case, the user may see icons 702—icon 706 which may be representations of image data based on XR content.

In some cases, the image data may be icons (e.g., as illustrated in FIG. 7) that may, or may not, be selectable to provide additional information. In other cases, the image data may include a two-dimensional (2D) image of XR content, for example, a rendered image of a character or object. In other cases, the image data my include augmentations such as a glow effect, a circle surrounding an object, or visual highlighting applied to a real-world object.

Returning to FIG. 6, in some aspects, XR device 606 may include a context determiner 614 that may determine a contextual information 618 of XR device 606 based on position data 616 and/or input data 608. For example, XR device 606 may obtain position data 616, which may be, or may include, an indication of a position of XR device 606. Position data 616 may include a geographic position of XR device 606 (e.g., a latitude and longitude). Additionally, position data 616 may include an orientation of XR device 606. Context determiner 614 may determine contextual information 618 based on position data 616. Additionally or alternatively, context determiner 614 may determine contextual information 618 based on input data 608 (e.g., images of the environment captured by XR device 606).

Contextual information 618 may include a position of XR device 606, an orientation of XR device 606, an description of an environment of XR device 606 (e.g., a classification, such as dessert, mountain, forest, city, indoor, outdoor, retail environment, office, home, arena, concert hall, classroom, etc.), a geographic-area description, (e.g., a country, state, county, zip code, etc.), a mode of operation of XR device 606 (e.g., AR mode, MR mode, tourist mode, shopping mode, outdoor-explorer mode, gaming mode, exercise mode, etc.), and/or a time (e.g., of day, day of the year, month or season). Context determiner 614 may be, or may include, one or more machine-learning models trained to classify environments based on images of the environments and/or position information (such as latitude and longitude).

In some aspects, machine-learning model 604 may determine data 610 based, at least in part, on contextual information 618. For example, machine-learning model 604 may be trained to generate images based, at least in part, on a context of the XR device on which the images are to be displayed. For example, machine-learning model 604 may be trained to generate different data for an office, when an XR device is in “work mode” than for a gym when an XR device is in “exercise mode.”

Context determiner 614, position data 616, and contextual information 618 are optional in system 600. The optional nature of context determiner 614, position data 616 and contextual information 618 is indicated by context determiner 614, position data 616, and contextual information 618 being illustrated using dashed lines.

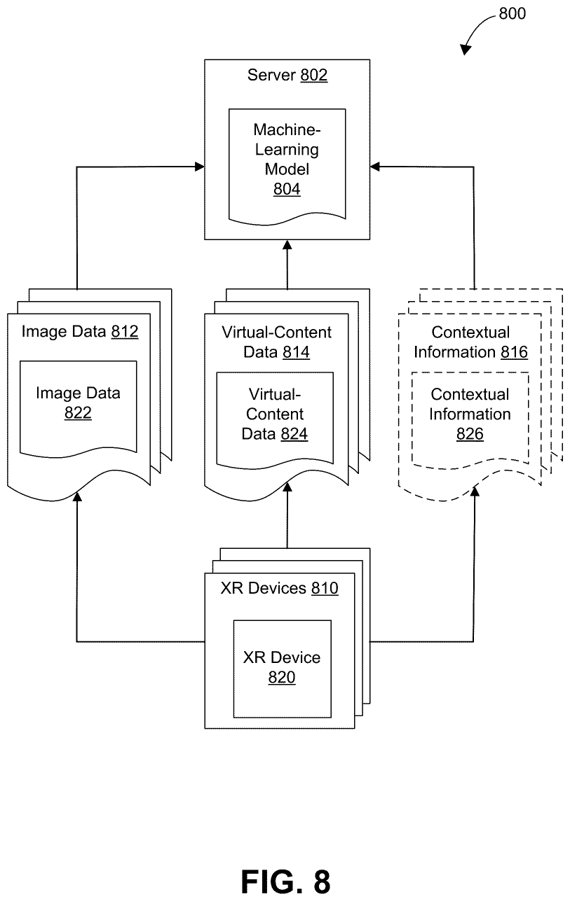

FIG. 8 is a block diagram illustrating an example system 800 for training a machine-learning model 804, according to various aspects of the present disclosure. In general, server 802 may obtain image data 812 and associated virtual-content data 814 and/or associated contextual information 816 from XR devices 810. Server 802 may train machine-learning model 804 based on image data 812, virtual-content data 814, and/or contextual information 816.

Server 802 may be, or may include, any suitable computing device or number of computing devices. Server 802 train machine-learning model 804. In some aspects, server 802 may perform the operations described with regard to server 602 of FIG. 6. For example, server 802 may store machine-learning model 804 and/or provide (e.g., transmit) machine-learning model 804 to one or more XR devices (e.g., machine-learning model 604 of FIG. 6).

Machine-learning model 804 may be the same as, may be substantially similar to, and/or may perform the same, or substantially the same, operations as machine-learning model 604 of FIG. 6. For example, machine-learning model 604 may be trained according to the operations described with regard to system 800.

XR devices 810 may be, or may include, a number (e.g., hundreds, thousands, or more) of XR devices. Each of XR devices 810 may be a respective example of XR device 104 of FIG. 1, display device 204, processing device 206, and/or companion device 208 of FIG. 2, XR device 302 of FIG. 3, and/or XR system 400 of FIG. 4.

One or more of XR devices 810 may generate respective instances of image data 812. For example, XR device 820 (an example one of XR devices 810) may include a scene-facing camera that may be used to capture images of a scene of XR device 820 (e.g., scene-facing image data). XR device 820 may transmit one or more images of the scene to server 802 as image data 822.

Additionally, the one or more of XR devices 810 may generate instances of virtual-content data 814 associated with the instances of image data 812. Virtual-content data 814 may be, or may include, virtual content (and/or a description of virtual content) displayed by XR devices 810. In some aspects, virtual-content data 814 may include image data (e.g., the image data displayed by a display).

In other aspects, virtual-content data 814 may include a description (e.g., a textual description of content being displayed, a category associated with the content). The description may include an indication of a format of the virtual content (e.g., text, image, video, or any generic media description). Additionally or alternatively, the description may include an indication of a nature of the virtual content (e.g., recommendations, navigation directions, real-time alerts such as promotional offers, interactive user-interface (UI) elements). Additionally, virtual-content data 814 may include a display position (e.g., where on a display of XR devices 810 the virtual content is displayed). Additionally or alternatively, virtual-content data 814 may include a relative location/orientation of a point to which the virtual content is anchored.

In case in which virtual-content data 814 includes image data (e.g., rendered virtual content), virtual-content data 814 may include images of the scene (e.g., according to a video see through (VST)) technique for displaying virtual content. Alternatively, virtual-content data 814 may include virtual data without images of the scene (e.g., according to a transparent-display technique for displaying virtual content on a transparent display). In either case, virtual-content data 814 may include screen shots from respective displays of XR devices 810.

Virtual-content data 814 may be associated with image data 812. For instance, XR device 820 (an example one of XR devices 810) may capture an image of a scene (e.g., image data 822) and determine virtual content being displayed by XR device 820 when image data 822 is captured as virtual-content data 824. XR device 820 may associate image data 822 with virtual-content data 814 as a set. For example, XR device 820 may transmit a set including image data 822 and virtual-content data 824.

Server 802 may train machine-learning model 804 based on image data 812 and virtual-content data 814. For example, server 802 may train machine-learning model 804 to generate image data that is similar to virtual-content data 824 (or image data described by virtual-content data 824) based on image data 822. For instance, server 802 may use image data 822 and virtual-content data 824 as ground-truth training data and train machine-learning model 804 to generate image data that is similar to virtual-content data 824 when provided with an input that is the same as, or similar to image data 822.

For instance, server 802 may process image data 822 (e.g., an example image of image data 812) using machine-learning model 804 to generate data (e.g., an image). Server 802 may compare the data generated based on image data 822 to virtual-content data 824 (e.g., an image displayed by XR device 820 when XR device 820 captured image data 822). Server 802 may determine an error based on differences between the generated data and virtual-content data 824. Server 802 may adjust parameters (e.g., weights) of machine-learning model 804 such that in further iterations of the training process, when machine-learning model 804 processes image data 822, machine-learning model 804 generates an image that is more similar to virtual-content data 824.

Machine-learning model 804 may be, or may include, a generator of a generative artificial network (GAN). Server 802 may train the generator to generate data and a discriminator to distinguish between data generated by the generator and data including in a corpus of training data. For example, server 802 may cause the generator to generate data based on image data 822. Further, server 802 may cause the discriminator to determine which of virtual-content data 824 and the data generated by the generator is part of virtual-content data 814. Server 802 may iteratively adjust parameters of the generator and the discriminator based on whether the discriminator accurately distinguishes between data generated by the generator and data of virtual-content data 814. Through the process of training, the generator may become increasingly proficient at generating data that appears similar (e.g., undistinguishable) from data of virtual-content data 814 based on input data.

At inference, machine-learning model 804 may then generate image data that is similar to virtual-content data 824 when an XR device that runs machine-learning model 804 captures image data that is the same as, or similar to image data 822. For example, if XR device 606 runs machine-learning model 804, if input data 608 is the same as, or substantially similar to image data 822, (e.g., based on XR device 606 being in the same position as XR device 820 was when XR device 820 captured image data 822), machine-learning model 804 may generate data 610 that is similar to virtual-content data 824.

In some aspects, XR devices 810 may generate instances of contextual information 816 associated with instances of image data 812. Contextual information 816 may be, or may include, position information indicating a position of a camera of the XR device that captured the image data, orientation information indicating an orientation of the camera of the XR device that captured the image data, environmental information describing an environment of the camera that captured the image data, and/or use-case information describing a mode of operation of the XR device including the camera that captured the image data.

For example, XR device 820 may capture image data 822 and determine contextual information 826 related to image data 822. For example, XR device 820 may determine a geographic position of XR device 820 when XR device 820 captured image data 822 (e.g., using RF technologies, such as, Institute of Electrical and Electronics Engineers (IEEE) 802.11 (WiFi), received signal strength indication (RSSI), round trip time (RTT), new radio (NR) RTT angle of arrival (AoA), Bluetooth™ RSSI.

Additionally or alternatively, XR device 820 may determine an orientation of XR device 820 when XR device 820 captured image data 822. For example, XR device 820 may include an inertial measurement unit that XR device 820 may use to determine the orientation of XR device 820. Additionally or alternatively, XR device 820 may use computational geometry techniques, such as SLAM to determine the orientation of XR device 820.

Additionally or alternatively, XR device 820 may determine a description of an environment of XR device 820 when XR device 820 captured image data 822. The description of the environment may include, for example, a classification of the environment (e.g., as dessert, mountain, forest, city, indoor, outdoor, retail environment, office, home, arena, concert hall, classroom, etc.) a geographic-area description, (e.g., a region, a country, state, county, zip code, etc.), and/or a venue identifier associated with the environment (e.g., a name or brand associated with the environment). For example, XR device 820 may include one or more machine-learning models trained to classify environments based on images of the environments (e.g., image data 822) and/or position information (such as latitude and longitude).

Additionally or alternatively, XR device 820 may determine an operational mode (e.g., AR mode, MR mode, tourist mode, shopping mode, outdoor-explorer mode, gaming mode, exercise mode, etc.) of XR device 820 when XR device 820 captured image data 822. XR device 820 may include the operational mode in contextual information 826.

Contextual information 826 may be associated with image data 812. For instance, XR device 820 may capture an image of a scene (e.g., image data 822) and determine contextual information of XR device 820 when image data 822 is captured as contextual information 826. XR device 820 may associate contextual information 826 with image data 822 and virtual-content data 824 as a set. For example, XR device 820 may transmit a set including image data 822, virtual-content data 824, and contextual information 826.

In some aspects, server 802 may train machine-learning model 804 based on image data 812, virtual-content data 814, and contextual information 816. For example, server 802 may train machine-learning model 804 to generate image data that is similar to virtual-content data 824 (or image data described by virtual-content data 824) based on image data 822 and contextual information 826. For instance, server 802 may use image data 822, contextual information 826, and virtual-content data 824 as ground-truth training data and train machine-learning model 804 to generate image data that is similar to virtual-content data 824 when provided with inputs that are the same as, or similar to image data 822 and contextual information 826.

For instance, server 802 may process image data 822 (e.g., an example image of image data 812) and contextual information 826 (e.g., an example of contextual information 816) using machine-learning model 804 to generate data (e.g., an image). Server 802 may compare the data generated based on image data 822 and contextual information 826 to virtual-content data 824 (e.g., an image displayed by XR device 820 when XR device 820 captured image data 822 in a context described by contextual information 826). Server 802 may determine an error based on differences between the generated data and virtual-content data 824. Server 802 may adjust parameters (e.g., weights) of machine-learning model 804 such that in further iterations of the training process, when machine-learning model 804 processes image data 822 and contextual information 826, machine-learning model 804 generates an image that is more similar to virtual-content data 824.

At inference, machine-learning model 804 may then generate image data that is similar to virtual-content data 824 when an XR device that runs machine-learning model 804 captures image data that is the same as, or similar to image data 822 and when the XR device that runs machine-learning model 804 is in a context similar to contextual information 826. For example, if XR device 606 runs machine-learning model 804, if input data 608 is the same as, or substantially similar to image data 822, (e.g., based on XR device 606 being in the same position as XR device 820 was when XR device 820 captured image data 822), and contextual information 618 is substantially similar to contextual information 826 (e.g., based on XR device 606 having a similar position, orientation, geographic description, and/or operation mode as XR device 820 had when XR device 820 captured image data 822), machine-learning model 804 may generate data 610 that is similar to virtual-content data 824.

In some aspects, server 802 may analyze a quality, an accuracy, a completeness, and/or a reliability of image data 812. In other aspects, XR devices 810 may report a quality, an accuracy, a completeness, and/or a reliability of image data 812. In either case, based on the quality, accuracy, completeness, and/or reliability of image data 812, server 802 may take one of several actions. For example, based on image data 822 having a low quality (e.g., below a threshold, such as based on image data 812 having poor resolution, poor lighting, etc.), having a low accuracy (e.g., below a threshold, such as based on image data 812 inaccurately representing a scene of XR device 820, for example, based on poor lighting conditions, movement of XR device 820, etc.), being relatively incomplete (e.g., below a threshold, such as based on image data 812 not completely representing a view of the scene, for example, based on occlusions or lighting), and/or having a low reliability (e.g., below a threshold), server 802 may determine to take one of several actions.

The actions may include requesting additional image data from the XR device, the additional images captured from a different perspective, requesting a change in a reporting periodicity of the XR device, request that the XR device adjust one or more imaging parameters for capturing of additional image data, labelling the one or more images, and/or modifying the one or more images. For example, if image data 822 is low quality, low accuracy, incomplete, and/or unreliable (e.g., below one or more thresholds), server 802 may instruct XR device 820 to provide further image data (e.g., of image data 812) less frequently. Additionally or alternatively, server 802 may request that XR device 820 change an imaging parameter of XR device 820 for capturing further image data (e.g., of image data 812). For example, server 802 may request that XR device 820 change image-capture parameters, such as, shutter speed, ISO, focus length, resolution etc. and/or image-processing parameters, such as noise-reduction, gain, etc. Additionally or alternatively, server 802 may label image data 822 as “bad.” Server 802 may then adjust how server 802 uses image data 822 in training machine-learning model 804. For example, server 802 may determine to not use “bad” images of image data 812. Additionally or alternatively, server 802 may modify image data 822. For example, server 802 may perform operations to improve (e.g., correct brightness of) image data 822.

As an alternative example, if image data 822 is high quality, high accuracy, complete, and/or reliable (e.g., above one or more thresholds), server 802 may instruct XR device 820 to provide further image data (e.g., of image data 812) more frequently. For example, server 802 may request more training images from XR devices that provide high quality, high accuracy, complete, and/or reliable training data. Additionally or alternatively, server 802 may label image data 822 as “good.” Server 802 may then adjust how server 802 uses image data 822 in training machine-learning model 804. For example, server 802 may determine to “good” images of image data 812. Additionally or alternatively, server 802 may modify image data 822. For example, server 802 may replicate and modify image data 822 to generate augmented training data to use to train machine-learning model 804. Additionally or alternatively, server 802 may request that a user of XR device 820 capture additional images of the scene from different perspectives. For example, server 802 may request more training images of a scene, from different perspectives, from XR devices that provide good training data.

For instance, if a quality metric associated with image data 822 from XR device 820 drops below 30%, server 802 may suspend continuous data collection from XR device 820. Further, server 802 may switches to a low-periodicity for data collection (e.g., every 15 seconds) for XR device 820. When the data quality metric associated with image data from XR device 820 rises to above 30%, server 802 may switch back to continuous data collection and storage for image data from XR device 820.

Additionally or alternatively, in some aspects, server 802 may implement data augmentation. For example, for some environments, additional data can be generated to augment captured training data for the environments to improve the robustness of machine-learning model 804 during inference in the environments. For example, machine-learning model 804 may be more robust in a given environment due to machine-learning model 804 having been trained using various augmented versions of training data for the given environment.

For instance, server 802 may perform geometric transformations on image data 822 to generate additional training data. For example, server 802 may simulate changing a point-of-view from which image data 822 were capture by translating image data 822 (e.g., shifting image data 822 horizontally or vertically, and/or scaling, zooming in/out within image data 822). Additionally or alternatively, server 802 may perform color-related operations, such as changing the brightness, contrast, saturation, and hue of image data 822.

Additionally or alternatively, server 802 may request that XR device 820 modify its camera parameters to collect and report image data 822 with the (e.g., with geometrical variations and/or color variations). In some aspects, server 802 may request that a user make the modifications. In other aspects, server 802 may request that XR device 820 make the modifications. Additionally or alternatively, server 802 may request that the user physically change their point-of-view (e.g., “look to the left and right further by another 5-10 degrees” or “move side-to-side periodically” as opposed to walking straight) to increase the diversity of image data 822. Such requests may be expressed as virtual content, such as AR prompts. Additionally or alternatively, such requests may appear as text or image-based notifications.

Contextual information 816 is optional in system 800. The optional nature of contextual information 816 is indicated by contextual information 816 being illustrated using dashed lines.

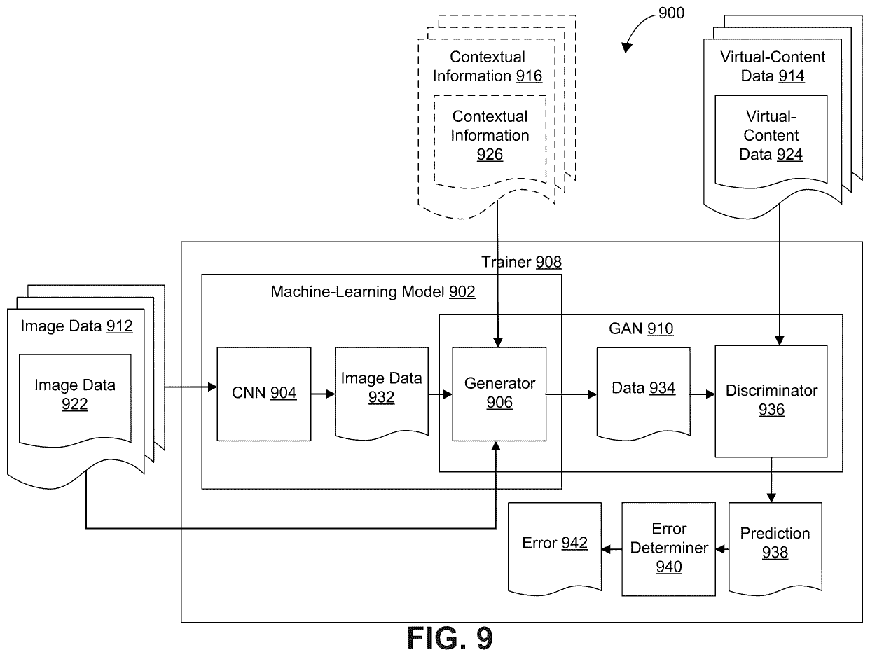

FIG. 9 is a block diagram of an example system 900 for training a machine-learning model 902, according to various aspects of the present disclosure. Machine-learning model 902 may be an example of machine-learning model 604 of FIG. 6 and/or machine-learning model 804 of FIG. 8. Server 802 of FIG. 8 may implement system 900 to train machine-learning model 804 or machine-learning model 604.

Machine-learning model 902 may include a convolutional neural network (CNN) 904 and a generator 906 of a generative adversarial network (GAN) 910. In some aspects, system 900 may train CNN 904 and GAN 910 together through an end-to-end training process. In other aspects, system 900 may treat CNN 904 as frozen and train GAN 910.

In general, trainer 908 may train machine-learning model 902 to generate virtual content that is similar to virtual-content data 914. In some aspects, virtual-content data 914 may include virtual content displayed by XR devices. For example, virtual-content data 914 may be an example of virtual-content data 814 of FIG. 8.

Further, trainer 908 may train machine-learning model 902 to generate virtual content that corresponds to input image data. For example, image data 912 may include images captured by scene-facing cameras of XR devices. For instance, image data 912 may be an example of image data 812 of FIG. 8. Image data 912 may include example image data 922 captured by an XR device at a given time. Virtual-content data 914 may include example virtual-content data 924 displayed by the XR device at the given time (e.g., virtual content that corresponds to image data 922). Trainer 908 may train machine-learning model 902 to generate virtual content that is similar to virtual-content data 914 based on receiving corresponding image data 912 as an input. For example, trainer 908 may train machine-learning model 902 to generate virtual content that is similar to virtual-content data 924 based on receiving image data 922 as an input. In other words, trainer 908 may train machine-learning model 902 to process image data 922 to generate virtual content that is similar to virtual-content data 924.

Additionally or alternatively, trainer 908 may train generator 906 to generate virtual-content data 914 based on image data 912 and contextual information 916. Contextual information 916 may include contextual information related to XR devices that captured image data 912 and/or to virtual-content data 914 displayed by the XR devices. Contextual information 916 may be an example of contextual information 816 of FIG. 8. Contextual information 916 may include example contextual information 926 based on a context of an XR device when image data 922 was captured (which may correspond to the time virtual-content data 924 was displayed) (e.g., contextual data that corresponds to image data 922 and/or virtual-content data 924). Trainer 908 may train machine-learning model 902 to generate virtual content that is similar to virtual-content data 914 based on receiving corresponding image data 912 and contextual information 916 as inputs. For example, trainer 908 may train machine-learning model 902 to generate virtual content that is similar to virtual-content data 924 based on receiving image data 922 and contextual information 926 as inputs. In other words, trainer 908 may train machine-learning model 902 to process image data 922 and contextual information 926 to generate virtual content that is similar to virtual-content data 924.

At inference, machine-learning model 902 may be used to generate virtual content that is similar to virtual-content data 914 when provided with input image data that is similar to image data 912 and/or contextual information that is similar to contextual information 916. For example, image data 912 may include images captured in a particular location. Virtual-content data 914 may include virtual data displayed by XR devices in the particular location (e.g., at the time the images of the particular location were captured). Additionally or alternatively, contextual information 916 may include contextual data determined by the XR devices at the time the images were captured. If an XR device running machine-learning model 902 visits the particular location and captures images and/or generates contextual data related to the particular location, machine-learning model 902 may generate virtual content that is similar to the virtual content displayed by the XR devices.

To train GAN 910 (and/or CNN 904), system 900 may cause CNN 904 to process image data 912. In some cases, image data 912 may be an example of image data 812 of FIG. 8. For example, image data 912 may include image data captured by a scene-facing camera. In other cases, image data 912 may be an example of virtual-content data 814. For example, in some cases virtual-content data 814 includes images of a scene overlaid with virtual content, (e.g., in cases in which virtual-content data 814 includes video-see-through (VST) data). In such cases, image data 912 may be, or may include, screen captures of what is displayed at a display (e.g., including the captured image data and the rendered virtual content).

In cases in which image data 912 includes virtual content, CNN 904 may be, or may include, a machine-learning model trained to differentiate between virtual content and captured image data. For example, CNN 904 may be trained to distinguish pixels of image data that are generated virtual content from pixels that are based on a captured image of a scene. For example, image data 912 may include video-see-through (VST) image data including images of a scene overlaid with pixels of rendered virtual content. CNN 904 may be trained to determine which pixels of the image data 912 are based on an image of a scene and which are rendered virtual content. CNN 904 may process image data 912 to generate image data 932. Image data 932 may include an indication of which pixels of image data 922 are based on images of a scene and which are rendered virtual content.

In cases in which image data 912 includes images of a scene separate from virtual content, CNN 904 may be omitted from machine-learning model 902 or bypassed. In such cases, generator 906 may process image data 912 and not image data 932 (e.g., without image data 912 differentiating between image data representing the scene and image data based on virtual content).

Generator 906 may be trained by causing generator 906 to process image data 912 to generate data 934. Generator 906 may generate data 934 based on image data 912 and, in some cases, image data 932. In some cases, image data 912 may include captured images of a scene. In other cases, image data 912 may include screenshots from an XR device, including both real-world images of a scene and virtual content. In such cases, generator 906 may additionally process the indications of pixels and/or extracted features (e.g., output by CNN 904). In any case, generator 906 may generate data 934 based on pixels of image data 912 that were captured by a scene-facing camera of an XR device.

In some aspects, generator 906 may generate data 934 based on image data 912 and contextual information 916. For example, generator 906 may additionally process other data metrics such as the virtual content features, location measurements, and context, which may be included in contextual information 916.

GAN 910 includes generator 906 and discriminator 936. Generator 906 may take image data 912 as input and produce provisional output data (e.g., data 934). Discriminator 936 may evaluate data 934 to check the authenticity of data 934 against virtual-content data 914. For example, discriminator 936 may predict (e.g., generate prediction 938 indicating) whether data 934 is part of virtual-content data 914 or whether data 934 is generated by generator 906. Error determiner 940 may determine whether prediction 938 is correct or not and generate error 942 based on whether prediction 938 is accurate.

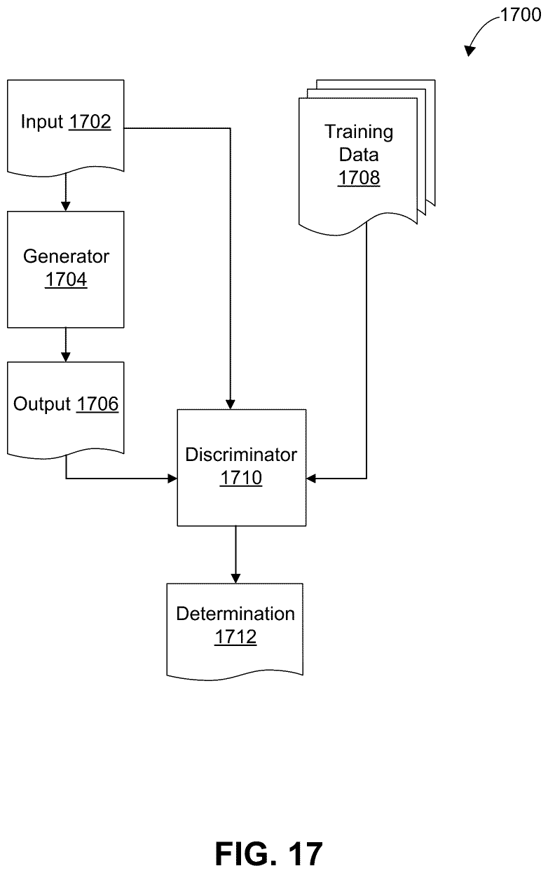

Trainer 908 may train generator 906 and discriminator 936 together through an adversarial training process. Generator 906 may generate data 934 to be similar to virtual-content data 914. Discriminator 936 may determine whether data 934 is part of virtual-content data 914 or generated by generator 906. If prediction 938 is correct, error determiner 940 determines error 942 and trainer 908 applies error 942 as a negative training example for generator 906. If prediction 938 is incorrect, error determiner 940 determines error 942 and trainer 908 applies error 942 as a negative training example for discriminator 936. Over iterations of the training process, the training improves the ability of generator 906 to create virtual content that is similar to virtual-content data 914 (e.g., training virtual content). Additionally, the training improves the ability of discriminator 936 to distinguish training virtual content from virtual content generated by generator 906. Additional detail regarding an example of training a generator in a GAN is provided with regard to FIG. 17.

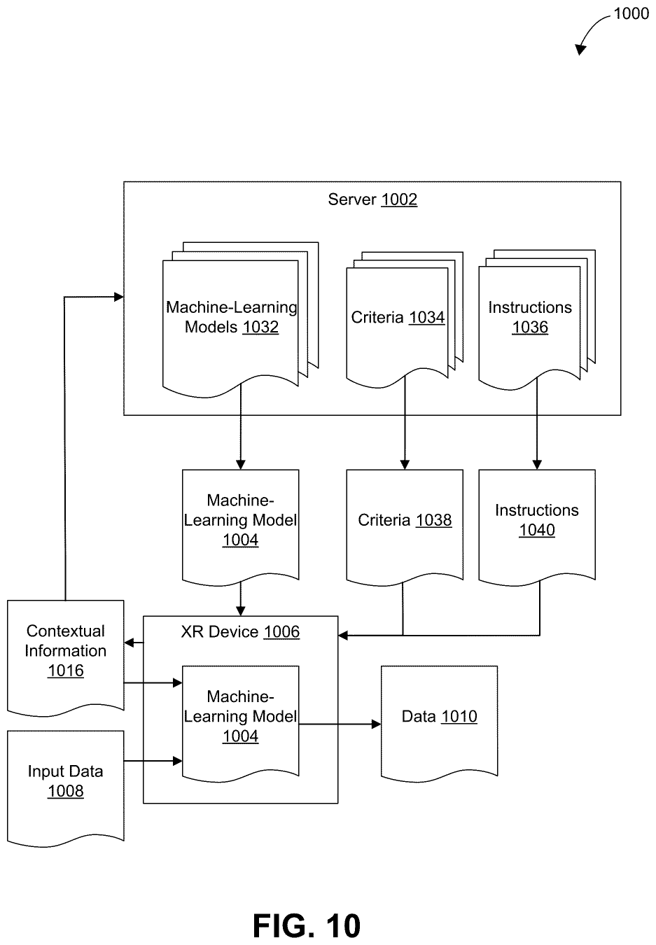

FIG. 10 is a block diagram of an example system 1000 for generating data 1010, according to various aspects of the present disclosure. In general, XR device 1006 may provide contextual information 1016 to server 1002. Server 1002 may select machine-learning model 1004 from among machine-learning models 1032 based on contextual information 1016. Further, server 1002 may provide machine-learning model 1004 to XR device 1006 and XR device 1006 may use machine-learning model 1004 to process input data 1008 to generate data 1010.

Server 1002 may be substantially the same as, may be substantially similar to, and/or may perform the same, or substantially the same, operations as server 602 of FIG. 6 and/or server 802 of FIG. 8. Machine-learning model 1004 may be the same as, may be substantially similar to, and/or may perform the same, or substantially the same, operations as machine-learning model 604 of FIG. 4 and/or machine-learning model 804 of FIG. 8. XR device 1006 may be the same as, may be substantially similar to, and/or may perform the same, or substantially the same, operations as XR device 606 of FIG. 6 and/or XR devices 810 of FIG. 8.

Additionally, server 1002 may store a plurality of machine-learning models 1032. Each of the plurality of machine-learning models 1032 may be trained based on different contextual information and/or image data. For example, machine-learning models 1032 may include an example machine-learning model 1004 that may have been trained based on image data and/or contextual data associated with a particular location (e.g., a range of latitude and longitude values), a geographic region (e.g., a region, country, county city, etc.), a venue type (e. g, indoor, outdoor, warehouse, retail store, airport, shopping mall, etc.), a venue identifier (e.g., a store or restaurant of a specific brand or retailer, etc.) time (e.g., day of the year, month, season, or time of day) and/or operational mode (e.g., tourist mode, sport mode, shopping mode, work mode, etc.). For example, according to the process described with regard to FIG. 8, machine-learning model 1004 may have been trained using image data 812, virtual-content data 814, and contextual information 816 that is all associated with the same (or a related) location, geographic region, venue type, a venue identifier, time and/or operational mode.

For instance, machine-learning model 1004 may have been trained using image data 812, virtual-content data 814, and contextual information 816 from a 10-meter-by-10-meter area having a known latitude and longitude. The area may be in a known country, city, county, neighborhood etc. The area may be in a particular region (e.g., the American West Coast or San Diego County). The area may be associated with a particular venue type (e.g., an office building, a restaurant, a museum, a park, a beach, etc.). The area may be associated with a particular company. Additionally or alternatively, the machine-learning model 1004 may have been trained using image data 812, virtual-content data 814, and contextual information 816 associated with a particular time (e.g., evening, morning, December, etc.) and/or operational mode (e.g., work mode, game mode, or tourist mode).

Machine-learning models 1032 may include machine-learning models trained based on image data, virtual-content data, and contextual information associated with a variety of locations, geographic regions, venue types, venue identifiers, times and/or operational modes. For example, machine-learning models 1032 may include dozens, hundreds, or more of machine-learning models, each trained using image data, virtual-content data, and contextual information associated with a different location, geographic region, venue type, venue identifier, time operational mode. Each of machine-learning models 1032 may be stored with appropriate identifiers allowing machine-learning models 1032 to be select by server 1002 based on locations, geographic regions, venue types, venue identifiers, times and/or operational modes or any combination thereof.

XR device 1006 may generate contextual information 1016 based on an environment in which XR device 1006 is operating. Contextual information 1016 may be the same as, or may be substantially similar to, contextual information 618 of FIG. 6. XR device 1006 may provide contextual information 1016 to server 1002. In some aspects, contextual information 1016 may include, for example, a coarse location estimate (e.g., based on RF technology measurements such as WiFi service set identifier (SSID) that indicates a location name or a cell tower identifier). Additionally or alternatively, contextual information 1016 may include a precise position (e.g., a latitude and longitude based on a global positioning system (GPS) service). In some aspects, may include position information determined according to a computational geometry technique based on images captured by XR device 1006. Additionally or alternatively, contextual information 1016 may include a time and/or an operational mode of XR device 1006.

In some aspects, contextual information 1016 may include a classification of the environment of XR device 1006. For example, in some aspects, XR device 1006 may include a machine-learning model trained to classify an environment of XR device 1006 based on image of the environment and/or position information of XR device 1006. For example, XR device 1006 may include a context determiner (e.g., context determiner 614 of FIG. 6) that may classify an environment of XR device 1006.

Additionally or alternatively, contextual information 1016 may include images of an environment of XR device 1006. Server 1002 may determine the position of XR device 1006 and/or a classification of the environment based on the images. Additionally or alternatively, contextual information 1016 may include position information related to the environment (e.g., a latitude and longitude) and server 1002 may classify the environment based on the position information.

Server 1002 may identify one or more machine-learning models (e.g., machine-learning model 1004) from among machine-learning models 1032 based on contextual information 1016 provided by XR device 1006. For example, based on contextual information 1016 indicating that XR device 1006 is in a particular location, server 1002 may select machine-learning model 1004 that relates to the particular location from among machine-learning models 1032. Additionally or alternatively, server 1002 may select machine-learning model 1004 from among machine-learning models 1032 based on machine-learning model 1004 relating to the environment of XR device 1006. For example, if contextual information 1016 indicates that XR device 1006 is in a specific city, region, venue, etc. server 1002 may select machine-learning model 1004 because machine-learning model 1004 relates to the city, region, venue, etc.

For example, XR device 1006 may transmit a contextual information 1016 indicating a position of XR device 1006. Server 1002 may classify an environment of XR device 1006 based on the position information. Further, server 1002 may select machine-learning model 1004 based on the classification of the environment.

For instance, based on contextual information 1016, server 1002 may classify the environment of XR device 1006 according to a geographical area of the environment (e.g., a region of the world), a climate, an environment-type (such as urban, rural, forest, dessert, hills, etc.), a venue class associated with the environment (e.g., a store, a school, a museum, a library, a stadium), and/or a venue identifier associated with the environment (e.g., a company name etc.). Server 1002 may select machine-learning model 1004 based on the classification of the environment. Additionally or alternatively, server 1002 may select machine-learning model 1004 based on a time (e.g., a current time) and/or an operational mode of XR device 1006.

In some aspects, server 1002 may select machine-learning model 1004 based on the highest level of specificity available. For example, if there is a machine-learning model of machine-learning models 1032 that relates to the specific location (e.g., latitude and longitude) of XR device 1006, a current time, and an operational mode of XR device 1006, server 1002 may select and provide that machine-learning model. If machine-learning models 1032 does not include a model that relates to the specific location of XR device 1006, time and operational mode, server 1002 may determine a most-relevant machine-learning model and transmit the most relevant machine-learning model. For example, if machine-learning models 1032 does not include a machine-learning model corresponding to the specific location, server 1002 may select a machine-learning model of machine-learning models 1032 that has the same venue type and/or region.

For example, server 1002 may determine that XR device 1006 is in a retail store of a particular brand, in San Diego County, California, that XR device 1006 is in a shopping mode, and the current time is evening. Machine-learning models 1032 may not include a machine-learning model specific to the geographic coordinates of XR device 1006, shopping mode, and evening. However, machine-learning models 1032 may include a machine-learning model for the particular brand of stores, a machine-learning model for San Diego County, a machine-learning model for California, and a machine-learning model for shopping. Server 1002 may determine which of the machine-learning models is most relevant and transmit the most relevant machine-learning model to XR device 1006.

In some aspects, server 1002 may select multiple machine-learning models to provide to XR device 1006. For example, returning to the above example, server 1002 may select and provide each of the machine-learning model for the particular brand of stores, the machine-learning model for San Diego County, the machine-learning model for California and the machine-learning model for shopping. In some aspects, if server 1002 transmits multiple machine-learning models to XR device 1006, XR device 1006 may determine a most relevant machine-learning model to use at a given time. Additionally or alternatively, server 1002 may run multiple machine-learning models at the same time.

Additionally, server 1002 may store criteria 1034 associated with machine-learning models 1032. For example, criteria 1034 may include criteria for when and/or how to use each of machine-learning models 1032. For example, criteria 1038 may include criteria for when and/or how to use criteria 1038. For example, criteria 1034 may include position-based criteria. For example, criteria 1038 may be a position-based criteria associated with machine-learning model 1004. A position-based criteria 1038 may describe a certain geographical region within which to use machine-learning model 1004. Other example categories of criteria include camera resolution, XR-device operating mode, time criteria, etc. Server 1002 may provide the criteria 1038 to XR device 1006 and XR device 1006 may use machine-learning model 1004 according to criteria 1038.

Additionally, server 1002 may store instructions 1036 associated with machine-learning models 1032. For example, instructions 1036 may include instructions for using each of machine-learning models 1032. For example, instructions 1040 may include instructions 1040 for using machine-learning model 1004. Such instructions may include formats for inputting data (e.g., input data 1008 and/or contextual information 1016) into machine-learning model 1004, a time at which machine-learning model 1004 may be updated or become obsolete, etc.

Server 1002 may provide criteria 1038 and instructions 1040 to XR device 1006 and XR device 1006 may use machine-learning model 1004 according to instructions 1040 and criteria 1038. For example, XR device 1006 may use machine-learning model 1004 to process input data 1008 and contextual information 1016 to generate data 1010 (e.g., image data to display at a display of XR device 1006).

In some aspects, XR device 1006 may provide input data 1008 including a raw camera feed as input to machine-learning model 1004. Machine-learning model 1004 may generate data 1010 include a list of virtual content/objects to be displayed along with their relative locations and orientations w.r. t the user. Alternatively, XR device 1006 may provide input data 1008 including the raw camera feed and the relative locations/orientations at which virtual content/object is desired. Machine-learning model 1004 may generate a list of virtual content/objects to be displayed at those corresponding locations/orientations.

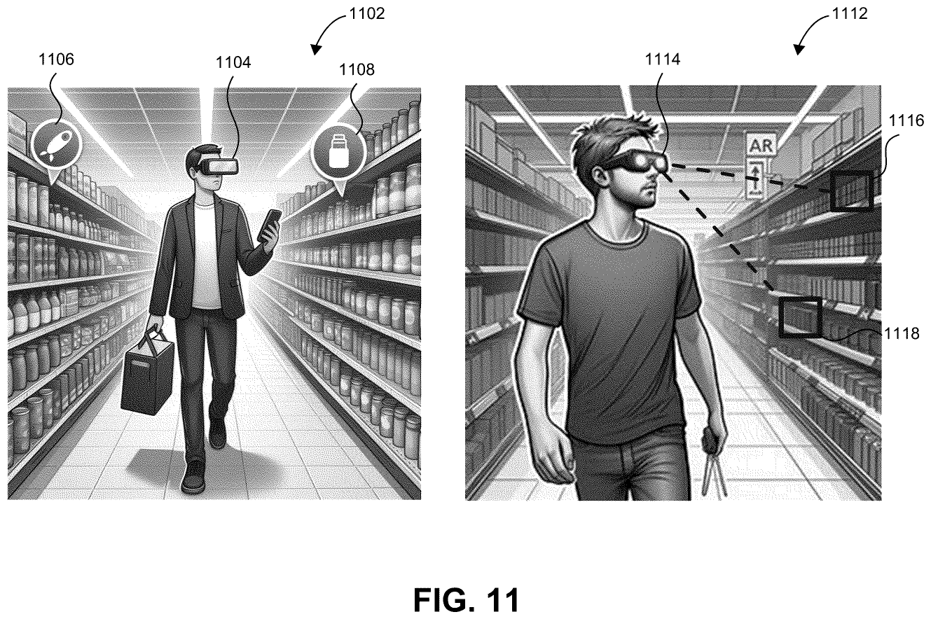

For example, FIG. 11 includes two illustrations of two respective example scenarios in which machine-learning model 1004 may generate virtual content for display, according to various aspects of the present disclosure. For example, according to scenario 1102, XR device 1104 may provide a camera feed (e.g., video captured by XR device 1104) as input to a machine-learning model (e.g., machine-learning model 1004 of FIG. 10). The machine-learning model may generate virtual content (e.g., icon 1106 and icon 1108) along with their respective intended relative locations/orientations.

According to scenario 1112, XR device 1114 may provide a camera feed and relative locations/orientations at which virtual content may be displayed (e.g., position 1116 and position 1118) to a machine-learning model (e.g., machine-learning model 1004 of FIG. 10). The machine-learning model may generate virtual content for the positions (e.g., position 1116 and position 1118).

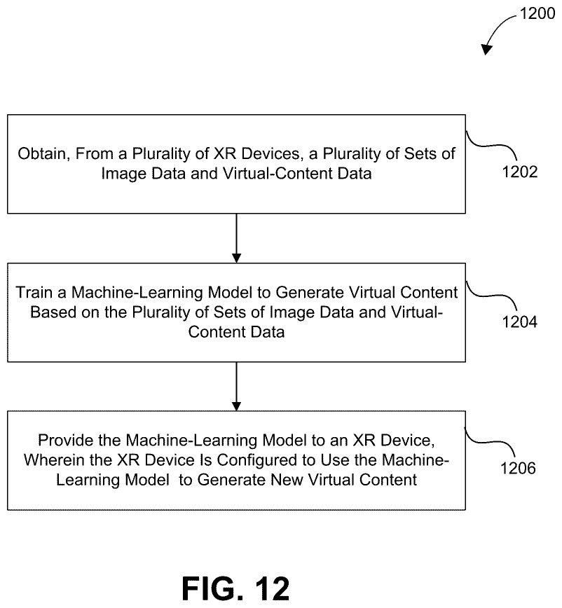

FIG. 12 is a flow diagram illustrating an example process 1200 for XR content, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1200. The one or more operations of process 1200 may be implemented as software components that are executed and run on one or more processors.

At block 1202, a computing device (or one or more components thereof) may obtain, from a plurality of XR devices, a plurality of sets of image data and virtual-content data. For example, server 802 may obtain sets of image data 812 and virtual-content data 814 from XR devices 810.

In some aspects, the image data may be, or may include, images captured by respective cameras of the plurality of XR devices. For example, image data 812 may be, or may include, images captured by respective cameras of XR devices 810.

In some aspects, the virtual-content data may be, or may include, pixel data displayed by respective displays of the plurality of XR devices. For example, virtual-content data 814 may be, or may include, respective pixel data displayed by XR devices 810.

In some aspects, the virtual-content data may be, or may include, descriptions of pixel data displayed by respective displays of the plurality of XR devices. For example, virtual-content data 814 may be, or may include, respective descriptions of pixel data displayed by XR devices 810.

In some aspects, each of the descriptions of pixel data comprises at least one of: a description of content represented by the pixel data; a category associated with the pixel data; or a display position related to the pixel data. For example, virtual-content data 814 may be, or may include, respective descriptions of pixel data displayed by XR devices 810. The respective descriptions may include a description of content represented by the pixel data, a category associated with the pixel data, and/or a display position related to the pixel data.

At block 1204, the computing device (or one or more components thereof) may train a machine-learning model to generate virtual content based on the plurality of sets of image data and virtual-content data. For example, server 802 may train machine-learning model 804 based on image data 812 and virtual-content data 814.

In some aspects, the computing device (or one or more components thereof) may obtain respective contextual information associated with each set of image data and virtual-content data, wherein the respective contextual information comprises at least one of: position information indicating a position of a camera that captured the image data, orientation information indicating an orientation of the camera that captured the image data, environmental information describing an environment of the camera that captured the image data, or use-case information describing a mode of operation of an XR device including the camera that captured the image data. The machine-learning model is trained based on the respective contextual information.

For example, server 802 may obtain contextual information 816 from XR devices 810. Contextual information 816 may correspond to received sets of image data 812 and virtual-content data 814. Contextual information 816 may include position information indicating a position of a camera that captured the image data, orientation information indicating an orientation of the camera that captured the image data, environmental information describing an environment of the camera that captured the image data, and/or use-case information describing a mode of operation of an XR device including the camera that captured the image data. Server 802 may train machine-learning model 804 based on image data 812, virtual-content data 814, and contextual information 816.

In some aspects, to train the machine-learning model, the computing device (or one or more components thereof) may train a generator machine-learning model along with a discriminator machine-learning model as a generative adversarial network, and wherein the machine-learning model provided to the XR device comprises the generator machine-learning model. For example, to train machine-learning model 902, trainer 908 may train generator 906 and discriminator 936 as GAN 910. Server 802 may provide machine-learning model 902 to XR device 820.

In some aspects, to train the machine-learning model, the at least one processor is configured to: process the image data using a classifier network to generate scene-image data and virtual image data; and train a generator machine-learning model based on the scene-image data and the virtual image data. For example, to train machine-learning model 902, trainer 908 may train CNN 904 to generate image data 932 (which may distinguish between scene image data and virtual image data). Trainer 908 may train GAN 910 based on image data 932.

At block 1206, the computing device (or one or more components thereof) may provide the machine-learning model to an XR device, wherein the XR device is configured to use the machine-learning model to generate new virtual content. For example, server 802 may provide machine-learning model 804 to XR device 820, (e.g., an example one of XR devices 810). XR device 820 may use machine-learning model 804 to generate new virtual content.

In some aspects, the XR device is configured to: determine a context of the XR device, wherein the context comprises at least one of: a position of the XR device, an orientation of the XR device, a description of an environment of the XR device, or a mode of operation of the XR device; and use the machine-learning model based on the respective contextual information and the context of the XR device. For example, XR device 820 may determine a context of XR device 820. The context may include a position of XR device 820, an orientation of XR device 820, a description of an environment of XR device 820, and/or a mode of operation of XR device 820. XR device 820 may determine to use machine-learning model 804 based on the context of XR device 820 corresponding to the context data used to train machine-learning model 804.

In some aspects, the computing device (or one or more components thereof) may obtain one or more images from an XR device; analyze at least one of a quality, an accuracy, a completeness, or a reliability of the one or more images; and based on the analysis, at least one of: request additional image data from the XR device, the additional image data to be captured from a different perspective; request a change in a reporting periodicity of the XR device; request that the XR device adjust one or more imaging parameters for capturing of additional image data; label the one or more images; or modify the one or more images. For example, server 802 may obtain image data 822 from XR devices 820. Server 802 may analyze a quality, an accuracy, a completeness, image data 822 and/or a reliability of XR device 820 in providing image data 822. Based on the analysis, server 802 may request that XR device 820 capture additional images from a different perspective. Additionally or alternatively, server 802 may request that XR device 820 send additional images more or less frequently. Additionally or alternatively, server 802 may request that XR device 820 adjust one or more imaging parameters for capturing of additional image data. Additionally or alternatively, server 802 may label image data 822 or modify image data 822.

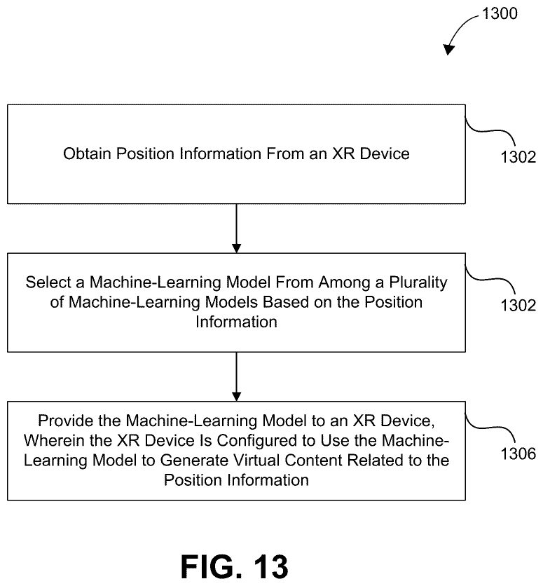

FIG. 13 is a flow diagram illustrating an example process 1300 for XR content, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1300. The one or more operations of process 1300 may be implemented as software components that are executed and run on one or more processors.

At block 1302, a computing device (or one or more components thereof) may obtain position information from an XR device. For example, server 1002 may receive contextual information 1016 from XR device 1006. Contextual information 1016 may include a position of XR device 1006.

At block 1304, the computing device (or one or more components thereof) may select a machine-learning model from among a plurality of machine-learning models based on the position information. For example, server 1002 may select machine-learning model 1004 from among machine-learning models 1032 based on the position of XR device 1006.

In some aspects, the computing device (or one or more components thereof) may classify an environment of the XR device based on the position information, wherein the machine-learning model is selected based on the classification of the environment. For example, server 1002 may classify an environment of XR device 1006 based on contextual information 1016. Further, server 1002 may select machine-learning model 1004 from among machine-learning models 1032 based on the classification of the environment of XR device 1006.

In some aspects, the environment is classified according to at least one of: a geographical area of the environment; a venue class associated with the environment; or a venue identifier associated with the environment. For example, server 1002 may classify the environment of XR device 1006 according to a geographical area of the environment; a venue class associated with the environment; or a venue identifier associated with the environment.

At block 1306, the computing device (or one or more components thereof) may provide the machine-learning model to the XR device, wherein the XR device is configured to use the machine-learning model to generate virtual content related to the position information. For example, server 1002 may provide machine-learning model 1004 to XR device 1006. XR device 1006 may use machine-learning model 1004.

In some aspects, the computing device (or one or more components thereof) may provide, to the XR device, operating instructions related to the machine-learning model. For example, server 1002 may provide instructions 1040 to XR device 1006.

In some aspects, the computing device (or one or more components thereof) may obtain, from a plurality of XR devices, a plurality of sets of image data and virtual-content data; and train the plurality of machine-learning models to generate virtual content based on the plurality of sets of image data and virtual-content data. For example, server 802 may obtain image data 812 and virtual-content data 814 from XR devices 810. Server 802 may train machine-learning models 1032 based on image data 812 and virtual-content data 814.

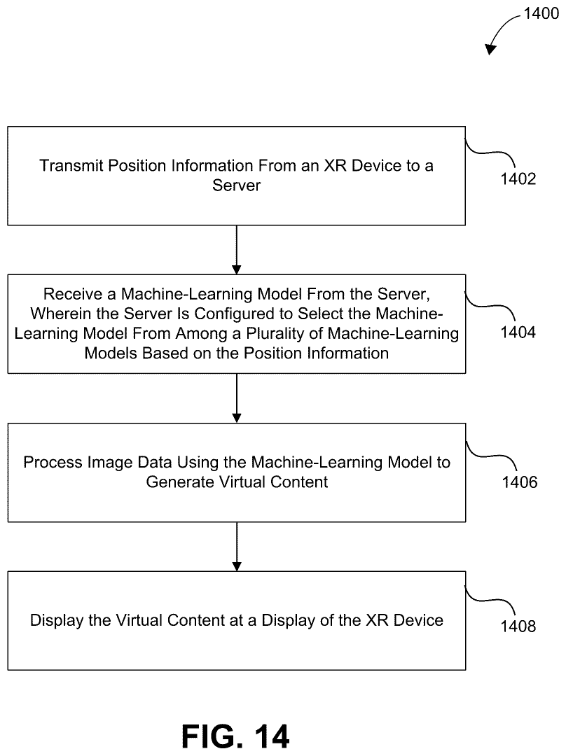

FIG. 14 is a flow diagram illustrating an example process 1400 for selecting XR content, in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1400. The one or more operations of process 1400 may be implemented as software components that are executed and run on one or more processors.

At block 1402, a computing device (or one or more components thereof) may transmit position information from an XR device to a server. For example, XR device 1006 may transmit contextual information 1016 to server 1002. Contextual information 1016 may include a position of 1006//.

At block 1404, the computing device (or one or more components thereof) may receive a machine-learning model from the server, wherein the server is configured to select the machine-learning model from among a plurality of machine-learning models based on the position information. For example, server 1002 may select machine-learning model 1004 from among machine-learning models 1032 based on the position of XR device 1006. Server 1002 may transmit machine-learning model 1004 to XR device 1006.

At block 1406, the computing device (or one or more components thereof) may process image data using the machine-learning model to generate virtual content. For example, XR device 1006 may process input data 1008 using machine-learning model 1004.

At block 1408, the computing device (or one or more components thereof) may display the virtual content at a display of the XR device. For example, XR device 1006 may display data 1010 at a display of XR device 1006.

In some aspects, the computing device (or one or more components thereof) may receive, from the server, operating instructions related to the machine-learning model, wherein the image data is processed according to the operating instructions. For example, XR device 1006 may obtain instructions 1040 from server 1002. XR device 1006 may process input data 1008 using machine-learning model 1004 based on instructions 1040.

In some examples, as noted previously, the methods described herein (e.g., process 1200 of FIG. 12, process 1300 of FIG. 13, process 1400 of FIG. 14, and/or other methods described herein) can be performed, in whole or in part, by a computing device or apparatus. In one example, one or more of the methods can be performed by XR device 104 of FIG. 1, display device 204 and companion device 208 of FIG. 2, XR device 302 of FIG. 3, XR system 400 of FIG. 4, SLAM system 500 of FIG. 5, system 600 of FIG. 6, system 800 of FIG. 8, system 900 of FIG. 9, system 1000 of FIG. 10, or by another system or device. In another example, one or more of the methods (e.g., process 1200, process 1300, process 1400, and/or other methods described herein) can be performed, in whole or in part, by the computing-device architecture 1800 shown in FIG. 18. For instance, a computing device with the computing-device architecture 1800 shown in FIG. 18 can include, or be included in, the components of the XR device 104 of FIG. 1, display device 204 and companion device 208 of FIG. 2, XR device 302 of FIG. 3, XR system 400 of FIG. 4, SLAM system 500 of FIG. 5, system 600 of FIG. 6, system 800 of FIG. 8, system 900 of FIG. 9, system 1000 of FIG. 10 and can implement the operations of process 1200, process 1300, process 1400, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1200, process 1300, process 1400, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200, process 1300, process 1400, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

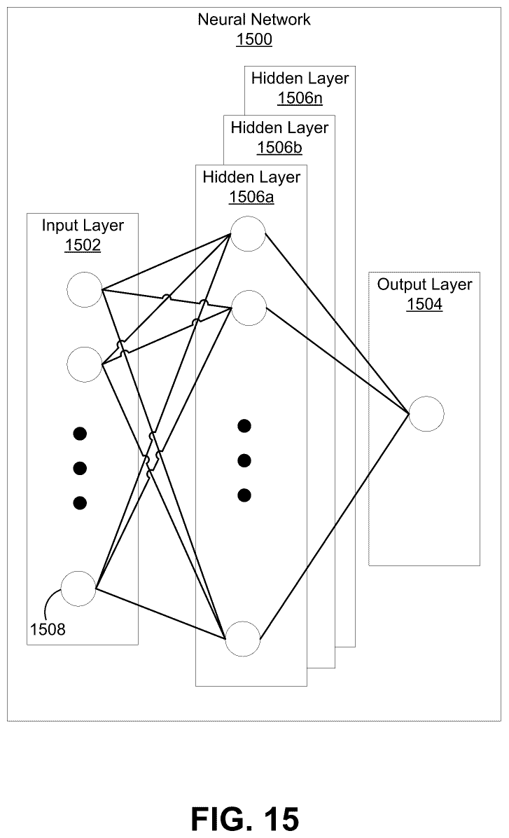

FIG. 15 is an illustrative example of a neural network 1500 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1500 may be an example of, or can implement, CNN 904 of FIG. 9.

An input layer 1502 includes input data. In one illustrative example, input layer 1502 can include data representing image data 912. Neural network 1500 includes multiple hidden layers, for example, hidden layers 1506a, 1506b, through 1506n. The hidden layers 1506a, 1506b, through hidden layer 1506n include “n” number of hidden layers, where “n” is an integer greater than or equal to one. The number of hidden layers can be made to include as many layers as needed for the given application. Neural network 1500 further includes an output layer 1504 that provides an output resulting from the processing performed by the hidden layers 1506a, 1506b, through 1506n. In one illustrative example, output layer 1504 can provide image data 932.

Neural network 1500 may be, or may include, a multi-layer neural network of interconnected nodes. Each node can represent a piece of information. Information associated with the nodes is shared among the different layers and each layer retains information as information is processed. In some cases, neural network 1500 can include a feed-forward network, in which case there are no feedback connections where outputs of the network are fed back into itself. In some cases, neural network 1500 can include a recurrent neural network, which can have loops that allow information to be carried across nodes while reading in input.

Information can be exchanged between nodes through node-to-node interconnections between the various layers. Nodes of input layer 1502 can activate a set of nodes in the first hidden layer 1506a. For example, as shown, each of the input nodes of input layer 1502 is connected to each of the nodes of the first hidden layer 1506a. The nodes of first hidden layer 1506a can transform the information of each input node by applying activation functions to the input node information. The information derived from the transformation can then be passed to and can activate the nodes of the next hidden layer 1506b, which can perform their own designated functions. Example functions include convolutional, up-sampling, data transformation, and/or any other suitable functions. The output of the hidden layer 1506b can then activate nodes of the next hidden layer, and so on. The output of the last hidden layer 1506n can activate one or more nodes of the output layer 1504, at which an output is provided. In some cases, while nodes (e.g., node 1508) in neural network 1500 are shown as having multiple output lines, a node has a single output and all lines shown as being output from a node represent the same output value.

In some cases, each node or interconnection between nodes can have a weight that is a set of parameters derived from the training of neural network 1500. Once neural network 1500 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1500 to be adaptive to inputs and able to learn as more and more data is processed.

Neural network 1500 may be pre-trained to process the features from the data in the input layer 1502 using the different hidden layers 1506a, 1506b, through 1506n in order to provide the output through the output layer 1504. In an example in which neural network 1500 is used to identify features in images, neural network 1500 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1500 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1500 is trained well enough so that the weights of the layers are accurately tuned.

For the example of identifying objects in images, the forward pass can include passing a training image through neural network 1500. The weights are initially randomized before neural network 1500 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1500, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1500 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1500 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1500 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1500 can include any other deep network other than a CNN, such as an autoencoder, a deep belief nets (DBNs), a Recurrent Neural Networks (RNNs), among others.

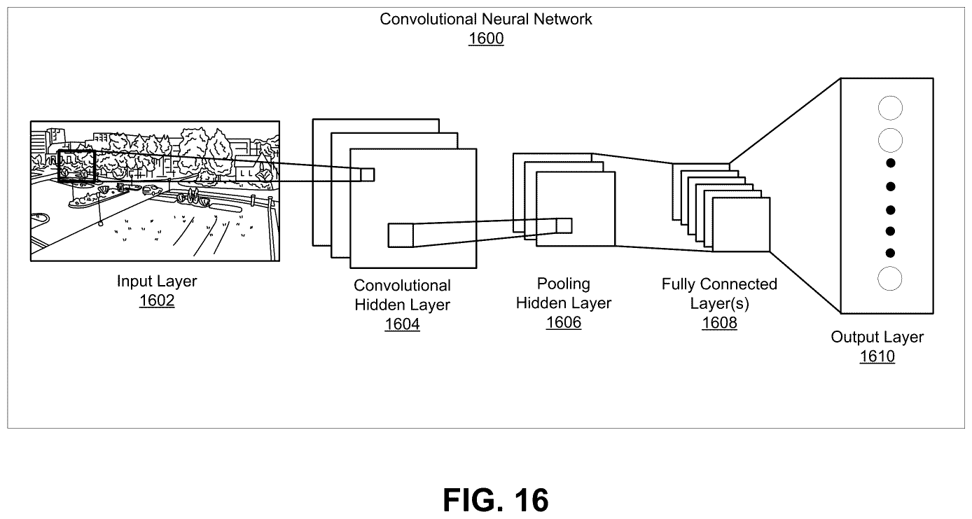

FIG. 16 is an illustrative example of a convolutional neural network (CNN) 1600. The input layer 1602 of the CNN 1600 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1604, an optional non-linear activation layer, a pooling hidden layer 1606, and fully connected layer 1608 (which fully connected layer 1608 can be hidden) to get an output at the output layer 1610. While only one of each hidden layer is shown in FIG. 16, one of ordinary skill will appreciate that multiple convolutional hidden layers, non-linear layers, pooling hidden layers, and/or fully connected layers can be included in the CNN 1600. As previously described, the output can indicate a single class of an object or can include a probability of classes that best describe the object in the image.

The first layer of the CNN 1600 can be the convolutional hidden layer 1604. The convolutional hidden layer 1604 can analyze image data of the input layer 1602. Each node of the convolutional hidden layer 1604 is connected to a region of nodes (pixels) of the input image called a receptive field. The convolutional hidden layer 1604 can be considered as one or more filters (each filter corresponding to a different activation or feature map), with each convolutional iteration of a filter being a node or neuron of the convolutional hidden layer 1604. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1604. Each connection between a node and a receptive field for that node learns a weight and, in some cases, an overall bias such that each node learns to analyze its particular local receptive field in the input image. Each node of the convolutional hidden layer 1604 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1604 is due to each node of the convolutional layer being applied to its corresponding receptive field. For example, a filter of the convolutional hidden layer 1604 can begin in the top-left corner of the input image array and can convolve around the input image. As noted above, each convolutional iteration of the filter can be considered a node or neuron of the convolutional hidden layer 1604. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1604. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1604.

The mapping from the input layer to the convolutional hidden layer 1604 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1604 can include several activation maps in order to identify multiple features in an image. The example shown in FIG. 16 includes three activation maps. Using three activation maps, the convolutional hidden layer 1604 can detect three different kinds of features, with each feature being detectable across the entire image.

In some examples, a non-linear hidden layer can be applied after the convolutional hidden layer 1604. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1600 without affecting the receptive fields of the convolutional hidden layer 1604.

The pooling hidden layer 1606 can be applied after the convolutional hidden layer 1604 (and after the non-linear hidden layer when used). The pooling hidden layer 1606 is used to simplify the information in the output from the convolutional hidden layer 1604. For example, the pooling hidden layer 1606 can take each activation map output from the convolutional hidden layer 1604 and generates a condensed activation map (or feature map) using a pooling function. Max-pooling is one example of a function performed by a pooling hidden layer. Other forms of pooling functions be used by the pooling hidden layer 1606, such as average pooling, L2-norm pooling, or other suitable pooling functions. A pooling function (e.g., a max-pooling filter, an L2-norm filter, or other suitable pooling filter) is applied to each activation map included in the convolutional hidden layer 1604. In the example shown in FIG. 16, three pooling filters are used for the three activation maps in the convolutional hidden layer 1604.

In some examples, max-pooling can be used by applying a max-pooling filter (e.g., having a size of 2×2) with a stride (e.g., equal to a dimension of the filter, such as a stride of 2) to an activation map output from the convolutional hidden layer 1604. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1604 having a dimension of 24×24 nodes, the output from the pooling hidden layer 1606 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1600.

The final layer of connections in the network is a fully-connected layer that connects every node from the pooling hidden layer 1606 to every one of the output nodes in the output layer 1610. Using the example above, the input layer includes 28×28 nodes encoding the pixel intensities of the input image, the convolutional hidden layer 1604 includes 3×24×24 hidden feature nodes based on application of a 5×5 local receptive field (for the filters) to three activation maps, and the pooling hidden layer 1606 includes a layer of 3×12×12 hidden feature nodes based on application of max-pooling filter to 2×2 regions across each of the three feature maps. Extending this example, the output layer 1610 can include ten output nodes. In such an example, every node of the 3×12×12 pooling hidden layer 1606 is connected to every node of the output layer 1610.

The fully connected layer 1608 can obtain the output of the previous pooling hidden layer 1606 (which should represent the activation maps of high-level features) and determines the features that most correlate to a particular class. For example, the fully connected layer 1608 can determine the high-level features that most strongly correlate to a particular class and can include weights (nodes) for the high-level features. A product can be computed between the weights of the fully connected layer 1608 and the pooling hidden layer 1606 to obtain probabilities for the different classes. For example, if the CNN 1600 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1610 can include an M-dimensional vector (in the prior example, M=10). M indicates the number of classes that the CNN 1600 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

Additionally, some of the machine-learning models described herein may be, or may include, generative adversarial networks (GANs). Such GANs may be trained using unsupervised-learning techniques. FIG. 17 illustrates a GAN architecture 1700. GAN architecture 1700 includes a generator 1704 and a discriminator 1710. Generator 1704 may be trained to generate data (e.g., image data, text data, video data, etc.) based on one or more input data (e.g., text descriptions, image data, video data, etc.). Discriminator 1710 may be trained to distinguish data that is generated by generator 1704 from data in a corpus of training data. Further, discriminator 1710 may be trained to distinguish data that is generated by generator 1704 based on input data in a corpus of training data that corresponds to input 1702. For example, discriminator 1710 may process output 1706 (e.g., data generated by generator 1704 based on input 1702) and a corresponding item of data from training data 1708 (e.g., data related to 1702). Discriminator 1710 may analyze the output 1706 and training data 1708 and make a determination 1712 indicating whether output 1706 is from training data 1708 or generated by generator 1704. Generator 1704 fools the discriminator 1710 when the determination 1712 is incorrect regarding the source of output 1706 and/or training data 1708.

Both the generator and the discriminator are neural networks with weights between nodes in respective layers, and these weights are optimized by training against training data 1708 (e.g., according to a backpropagation training process). The instances when generator 1704 successfully fools discriminator 1710 become negative training examples for discriminator 1710, and the weights of discriminator 1710 are updated using backpropagation. Similarly, the instances when generator 1704 is unsuccessfully in fooling discriminator 1710 become negative training examples for generator 1704, and the weights of generator 1704 are updated using backpropagation.

Once trained, generator 1704 may then be used as part of another system or device. For example, the other system or device may use generator 1704 to generate new data based on new inputs.

FIG. 18 illustrates an example computing-device architecture 1800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1800 may include, implement, or be included in any or all of XR device 104 of FIG. 1, display device 204 and companion device 208 of FIG. 2, XR device 302 of FIG. 3, XR system 400 of FIG. 4, SLAM system 500 of FIG. 5, system 600 of FIG. 6, system 800 of FIG. 8, system 900 of FIG. 9, system 1000 of FIG. 10 and/or other devices, modules, or systems described herein. Additionally or alternatively, computing-device architecture 1800 may be configured to perform process 1200 of FIG. 12, process 1300 of FIG. 13, process 1400 of FIG. 14, and/or other process described herein.

The components of computing-device architecture 1800 are shown in electrical communication with each other using connection 1812, such as a bus. The example computing-device architecture 1800 includes a processing unit (CPU or processor) 1802 and computing device connection 1812 that couples various computing device components including computing device memory 1810, such as read only memory (ROM) 1808 and random-access memory (RAM) 1806, to processor 1802.

Computing-device architecture 1800 can include a cache of high-speed memory connected directly with, in close proximity to, or integrated as part of processor 1802. Computing-device architecture 1800 can copy data from memory 1810 and/or the storage device 1814 to cache 1804 for quick access by processor 1802. In this way, the cache can provide a performance boost that avoids processor 1802 delays while waiting for data. These and other modules can control or be configured to control processor 1802 to perform various actions. Other computing device memory 1810 may be available for use as well. Memory 1810 can include multiple different types of memory with different performance characteristics. Processor 1802 can include any general-purpose processor and a hardware or software service, such as service 1 1816, service 2 1818, and service 3 1820 stored in storage device 1814, configured to control processor 1802 as well as a special-purpose processor where software instructions are incorporated into the processor design. Processor 1802 may be a self-contained system, containing multiple cores or processors, a bus, memory controller, cache, etc. A multi-core processor may be symmetric or asymmetric.

To enable user interaction with the computing-device architecture 1800, input device 1822 can represent any number of input mechanisms, such as a microphone for speech, a touch-sensitive screen for gesture or graphical input, keyboard, mouse, motion input, speech and so forth. Output device 1824 can also be one or more of a number of output mechanisms known to those of skill in the art, such as a display, projector, television, speaker device, etc. In some instances, multimodal computing devices can enable a user to provide multiple types of input to communicate with computing-device architecture 1800. Communication interface 1826 can generally govern and manage the user input and computing device output. There is no restriction on operating on any particular hardware arrangement and therefore the basic features here may easily be substituted for improved hardware or firmware arrangements as they are developed.

Storage device 1814 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1806, read only memory (ROM) 1808, and hybrids thereof. Storage device 1814 can include services 1816, 1818, and 1820 for controlling processor 1802. Other hardware or software modules are contemplated. Storage device 1814 can be connected to the computing device connection 1812. In one aspect, a hardware module that performs a particular function can include the software component stored in a computer-readable medium in connection with the necessary hardware components, such as processor 1802, connection 1812, output device 1824, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for extended reality (XR), the apparatus comprising: at least one memory; and at least one processor coupled to the at least one memory and configured to: obtain, from a plurality of XR devices, a plurality of sets of image data and virtual-content data; train a machine-learning model to generate virtual content based on the plurality of sets of image data and virtual-content data; and provide the machine-learning model to an XR device, wherein the XR device is configured to use the machine-learning model to generate new virtual content.
Aspect 2. The apparatus of aspect 1, wherein the image data comprises images captured by respective cameras of the plurality of XR devices.
Aspect 3. The apparatus of any one of aspects 1 or 2, wherein the virtual-content data comprises pixel data displayed by respective displays of the plurality of XR devices.
Aspect 4. The apparatus of any one of aspects 1 to 3, wherein the virtual-content data comprises descriptions of pixel data displayed by respective displays of the plurality of XR devices.
Aspect 5. The apparatus of aspect 4, wherein each of the descriptions of pixel data comprises at least one of: a description of content represented by the pixel data; a category associated with the pixel data; or a display position related to the pixel data.
Aspect 6. The apparatus of any one of aspects 1 to 5, wherein the at least one processor is configured to obtain respective contextual information associated with each set of image data and virtual-content data, wherein the respective contextual information comprises at least one of: position information indicating a position of a camera that captured the image data, orientation information indicating an orientation of the camera that captured the image data, environmental information describing an environment of the camera that captured the image data, or use-case information describing a mode of operation of an XR device including the camera that captured the image data; wherein the machine-learning model is trained based on the respective contextual information.
Aspect 7. The apparatus of aspect 6, wherein the XR device is configured to: determine a context of the XR device, wherein the context comprises at least one of: a position of the XR device, an orientation of the XR device, a description of an environment of the XR device, or a mode of operation of the XR device; and use the machine-learning model based on the respective contextual information and the context of the XR device.
Aspect 8. The apparatus of any one of aspects 1 to 7, wherein, to train the machine-learning model, the at least one processor is configured to train a generator machine-learning model along with a discriminator machine-learning model as a generative adversarial network, and wherein the machine-learning model provided to the XR device comprises the generator machine-learning model.
Aspect 9. The apparatus of any one of aspects 1 to 8, wherein, to train the machine-learning model, the at least one processor is configured to: process the image data using a classifier network to generate scene-image data and virtual image data; and train a generator machine-learning model based on the scene-image data and the virtual image data.
Aspect 10. The apparatus of any one of aspects 1 to 9, wherein the at least one processor is configured to: obtain one or more images from an XR device; analyze at least one of a quality, an accuracy, a completeness, or a reliability of the one or more images; and based on the analysis, at least one of: request additional image data from the XR device, the additional image data to be captured from a different perspective; request a change in a reporting periodicity of the XR device; request that the XR device adjust one or more imaging parameters for capturing of additional image data; label the one or more images; or modify the one or more images.
Aspect 11. An apparatus for extended reality (XR), the apparatus comprising: at least one memory; and at least one processor coupled to the at least one memory and configured to: obtain position information from an XR device; select a machine-learning model from among a plurality of machine-learning models based on the position information; and provide the machine-learning model to the XR device, wherein the XR device is configured to use the machine-learning model to generate virtual content related to the position information.
Aspect 12. The apparatus of aspect 11, wherein the at least one processor is configured to classify an environment of the XR device based on the position information, wherein the machine-learning model is selected based on the classification of the environment.
Aspect 13. The apparatus of aspect 12, wherein the environment is classified according to at least one of: a geographical area of the environment; a venue class associated with the environment; or a venue identifier associated with the environment.
Aspect 14. The apparatus of any one of aspects 11 to 13, wherein the at least one processor is configured to provide, to the XR device, operating instructions related to the machine-learning model.
Aspect 15. The apparatus of any one of aspects 11 to 14, wherein the at least one processor is configured to: obtain, from a plurality of XR devices, a plurality of sets of image data and virtual-content data; and train the plurality of machine-learning models to generate virtual content based on the plurality of sets of image data and virtual-content data.
Aspect 16. An apparatus for extended reality (XR), the apparatus comprising: at least one memory; and at least one processor coupled to the at least one memory and configured to: transmit position information from an XR device to a server; receive a machine-learning model from the server, wherein the server is configured to select the machine-learning model from among a plurality of machine-learning models based on the position information; process image data using the machine-learning model to generate virtual content; and display the virtual content at a display of the XR device.
Aspect 17. The apparatus of aspect 16, wherein the at least one processor is configured to receive, from the server, operating instructions related to the machine-learning model, wherein the image data is processed according to the operating instructions.
Aspect 18. A method for extended reality (XR), the method comprising: obtaining, from a plurality of XR devices, a plurality of sets of image data and virtual-content data; training a machine-learning model to generate virtual content based on the plurality of sets of image data and virtual-content data; and providing the machine-learning model to an XR device, wherein the XR device is configured to use the machine-learning model to generate new virtual content.
Aspect 19. The method of aspect 18, wherein the image data comprises images captured by respective cameras of the plurality of XR devices.
Aspect 20. The method of any one of aspects 18 or 19, wherein the virtual-content data comprises pixel data displayed by respective displays of the plurality of XR devices.
Aspect 21. The method of any one of aspects 18 to 20, wherein the virtual-content data comprises descriptions of pixel data displayed by respective displays of the plurality of XR devices.
Aspect 22. The method of aspect 21, wherein each of the descriptions of pixel data comprises at least one of: a description of content represented by the pixel data; a category associated with the pixel data; or a display position related to the pixel data.
Aspect 23. The method of any one of aspects 18 to 22, further comprising obtaining respective contextual information associated with each set of image data and virtual-content data, wherein the respective contextual information comprises at least one of: position information indicating a position of a camera that captured the image data, orientation information indicating an orientation of the camera that captured the image data, environmental information describing an environment of the camera that captured the image data, or use-case information describing a mode of operation of an XR device including the camera that captured the image data; wherein the machine-learning model is trained based on the respective contextual information.
Aspect 24. The method of aspect 23, wherein the XR device is configured to: determine a context of the XR device, wherein the context comprises at least one of: a position of the XR device, an orientation of the XR device, a description of an environment of the XR device, or a mode of operation of the XR device; and use the machine-learning model based on the respective contextual information and the context of the XR device.
Aspect 25. The method of any one of aspects 18 to 24, wherein training the machine-learning model comprises training a generator machine-learning model along with a discriminator machine-learning model as a generative adversarial network, and wherein the machine-learning model provided to the XR device comprises the generator machine-learning model.
Aspect 26. The method of any one of aspects 18 to 25, wherein training the machine-learning model comprises: processing the image data using a classifier network to generate scene-image data and virtual image data; and training a generator machine-learning model based on the scene-image data and the virtual image data.
Aspect 27. The method of any one of aspects 18 to 26, further comprising: obtaining one or more images from an XR device; analyzing at least one of a quality, an accuracy, a completeness, or a reliability of the one or more images; and based on the analysis, at least one of: requesting additional image data from the XR device, the additional image data to be captured from a different perspective; requesting a change in a reporting periodicity of the XR device; requesting that the XR device adjust one or more imaging parameters for capturing of additional image data; labelling the one or more images; or modifying the one or more images.
Aspect 28. A method for extended reality (XR), the method comprising: obtaining position information from an XR device; selecting a machine-learning model from among a plurality of machine-learning models based on the position information; and providing the machine-learning model to the XR device, wherein the XR device is configured to use the machine-learning model to generate virtual content related to the position information.
Aspect 29. The method of aspect 28, further comprising classifying an environment of the XR device based on the position information, wherein the machine-learning model is selected based on the classification of the environment.
Aspect 30. The method of aspect 29, wherein the environment is classified according to at least one of: a geographical area of the environment; a venue class associated with the environment; or a venue identifier associated with the environment.
Aspect 31. The method of any one of aspects 28 to 30, further comprising providing, to the XR device, operating instructions related to the machine-learning model.
Aspect 32. The method of any one of aspects 28 to 31, further comprising: obtaining, from a plurality of XR devices, a plurality of sets of image data and virtual-content data; and training the plurality of machine-learning models to generate virtual content based on the plurality of sets of image data and virtual-content data.
Aspect 33. A method for extended reality (XR), the method comprising: transmitting position information from an XR device to a server; receiving a machine-learning model from the server, wherein the server is configured to select the machine-learning model from among a plurality of machine-learning models based on the position information; processing image data using the machine-learning model to generate virtual content; and displaying the virtual content at a display of the XR device.
Aspect 34. The method of aspect 33, further comprising receiving, from the server, operating instructions related to the machine-learning model, wherein the image data is processed according to the operating instructions.
Aspect 35. A non-transitory computer-readable storage medium having stored thereon instructions that, when executed by at least one processor, cause the at least one processor to perform operations according to any of aspects 18 to 34.
Aspect 36. An apparatus for providing virtual content for display, the apparatus comprising one or more means for perform operations according to any of aspects 18 to 34.

What is claimed is:

1. An apparatus for extended reality (XR), the apparatus comprising:
at least one memory; and
at least one processor coupled to the at least one memory and configured to:
obtain, from a plurality of XR devices, a plurality of sets of image data and virtual-content data;
train a machine-learning model to generate virtual content based on the plurality of sets of image data and virtual-content data; and
provide the machine-learning model to an XR device, wherein the XR device is configured to use the machine-learning model to generate new virtual content.

2. The apparatus of claim 1, wherein the image data comprises images captured by respective cameras of the plurality of XR devices.

3. The apparatus of claim 1, wherein the virtual-content data comprises pixel data displayed by respective displays of the plurality of XR devices.

4. The apparatus of claim 1, wherein the virtual-content data comprises descriptions of pixel data displayed by respective displays of the plurality of XR devices.

5. The apparatus of claim 4, wherein each of the descriptions of pixel data comprises at least one of:
a description of content represented by the pixel data;
a category associated with the pixel data; or
a display position related to the pixel data.

6. The apparatus of claim 1, wherein the at least one processor is configured to obtain respective contextual information associated with each set of image data and virtual-content data, wherein the respective contextual information comprises at least one of:
position information indicating a position of a camera that captured the image data,
orientation information indicating an orientation of the camera that captured the image data,
environmental information describing an environment of the camera that captured the image data, or use-case information describing a mode of operation of an XR device including the camera that captured the image data;
wherein the machine-learning model is trained based on the respective contextual information.

7. The apparatus of claim 6, wherein the XR device is configured to:
determine a context of the XR device, wherein the context comprises at least one of:
a position of the XR device,
an orientation of the XR device,
a description of an environment of the XR device, or a mode of operation of the XR device; and
use the machine-learning model based on the respective contextual information and the context of the XR device.

8. The apparatus of claim 1, wherein, to train the machine-learning model, the at least one processor is configured to train a generator machine-learning model along with a discriminator machine-learning model as a generative adversarial network, and wherein the machine-learning model provided to the XR device comprises the generator machine-learning model.

9. The apparatus of claim 1, wherein, to train the machine-learning model, the at least one processor is configured to:
process the image data using a classifier network to generate scene-image data and virtual image data; and
train a generator machine-learning model based on the scene-image data and the virtual image data.

10. The apparatus of claim 1, wherein the at least one processor is configured to:
obtain one or more images from an XR device;
analyze at least one of a quality, an accuracy, a completeness, or a reliability of the one or more images; and
based on the analysis, at least one of:
request additional image data from the XR device, the additional image data to be captured from a different perspective;
request a change in a reporting periodicity of the XR device;
request that the XR device adjust one or more imaging parameters for capturing of additional image data;
label the one or more images; or
modify the one or more images.

11. An apparatus for extended reality (XR), the apparatus comprising:
at least one memory; and
at least one processor coupled to the at least one memory and configured to:
obtain position information from an XR device;
select a machine-learning model from among a plurality of machine-learning models based on the position information; and
provide the machine-learning model to the XR device, wherein the XR device is configured to use the machine-learning model to generate virtual content related to the position information.

12. The apparatus of claim 11, wherein the at least one processor is configured to classify an environment of the XR device based on the position information, wherein the machine-learning model is selected based on the classification of the environment.

13. The apparatus of claim 12, wherein the environment is classified according to at least one of:
a geographical area of the environment;
a venue class associated with the environment; or
a venue identifier associated with the environment.

14. The apparatus of claim 11, wherein the at least one processor is configured to provide, to the XR device, operating instructions related to the machine-learning model.

15. The apparatus of claim 11, wherein the at least one processor is configured to:
obtain, from a plurality of XR devices, a plurality of sets of image data and virtual-content data; and
train the plurality of machine-learning models to generate virtual content based on the plurality of sets of image data and virtual-content data.

16. A method for extended reality (XR), the method comprising:
obtaining, from a plurality of XR devices, a plurality of sets of image data and virtual-content data;
training a machine-learning model to generate virtual content based on the plurality of sets of image data and virtual-content data; and
providing the machine-learning model to an XR device, wherein the XR device is configured to use the machine-learning model to generate new virtual content.

17. The method of claim 16, wherein the image data comprises images captured by respective cameras of the plurality of XR devices.

18. The method of claim 16, wherein the virtual-content data comprises pixel data displayed by respective displays of the plurality of XR devices.

19. The method of claim 16, wherein the virtual-content data comprises descriptions of pixel data displayed by respective displays of the plurality of XR devices.

20. The method of claim 19, wherein each of the descriptions of pixel data comprises at least one of:
a description of content represented by the pixel data;
a category associated with the pixel data; or
a display position related to the pixel data.
